(19) United States
(12) Patent Application Publication
(10) Pub. No.: US 2020/0242154 A1
(43) Pub. Date: Jul. 30, 2020

(54) IMAGE FILE GENERATING DEVICE AND IMAGE FILE GENERATING METHOD

(71) Applicant: Olympus Corporation, Tokyo (JP)

(72) Inventors: Kazuhiro HANEDA, Tokyo (JP); Hisashi YONEYAMA, Tokyo (JP); Zhen LI, Tokyo (JP); Dai ITO, Tokyo (JP); Kazuhiko OSA, Tokyo (JP); Osamu NONAKA, Sagamihara-shi (JP)

(21) Appl. No.: 16/742,829

(22) Filed: Jan. 14, 2020

(30) Foreign Application Priority Data
Jan. 24, 2019 (JP) 2019-010405
Jan. 30, 2019 (JP) 2019-014900

(51) Int. Cl. G06F 16/583; G06F 16/538; G06N 20/00; G06K 9/62; G06K 9/78; G06N 5/04; G06F 16/535

(52) U.S. Cl. CPC G06F 16/583; G06F 16/538; G06N 20/00; G06F 16/535; G06K 9/78; G06N 5/04; G06K 9/6256

(57) ABSTRACT

An image file generating device that generates image files constituting training data candidates, comprising a processor that has a metadata generating section for generating metadata in order to designate (1) if inference is for detecting a physical object within an image, and (2) whether inference is for predicting change in images that are continuous in time, wherein the metadata generating section generates the metadata based on information corresponding to times before and after the images have been acquired.

### CROSS-REFERENCE TO RELATED APPLICATIONS

Benefit is claimed, under 35 U.S.C. § 119, to the filing date of prior Japanese Patent Application Nos. 2019-010405 filed on Jan. 24, 2019, and 2019-014900 filed on Jan. 30, 2019. These applications are expressly incorporated herein by reference. The scope of the present invention is not limited to any requirements of the specific embodiments described in the application.

### BACKGROUND OF THE INVENTION

### 1. Field of the Invention

The present invention relates to an image file generating device and image file generating method for generating an image file that is used when requesting generation of an inference model to a machine learning device for deep learning etc.

### 2. Description of the Related Art

It is known to perform learning in a learning section, and to perform various controls using results of this learning. For example, a device that learns characteristics at a normal time from observation data that has been gathered, and based on learning results detects occurrence of abnormality in observation data input after that, is disclosed in Japanese patent laid-open No. 2018-148350 (hereafter referred to as “patent publication 1”). With this device, abnormality rate is calculated based on data that has been observed from an abnormal detection target in a test period, and occurrence of abnormality is detected by comparing this abnormality rate with a threshold value. A threshold value is then determined based on whether or not there has been overlooking of abnormality, and error detection, and if error detection has occurred the threshold value is increased, while if overlooking has occurred the threshold value is reduced.

With the device described in patent publication 1 above, although level adjustment of results that have been learned is performed, relearning based on results of level adjustment is not performed. However, with a scene that actually uses inference based on learning results, various conditions are different according to the situation of that scene, and simply creating an inference model using only phenomenon that have occurred in a test period is not always sufficient. Specifically, it is desired to generate training data for an actual scene that changes minute by minute, and to perform maintenance of a learning model.

### SUMMARY OF THE INVENTION

The present invention provides an image file generating device and image file generating method for generating an image file such that it is possible to perform inference of high reliability using information possessed by an image.

An image file generating device of a first aspect of the present invention generates an image file having training data candidates, and comprises a processor having a metadata generating section for designating that purpose of an inference model that will be created is for prediction, and a processor having a metadata generating section for generating metadata for designating (1) if inference is for detecting a physical object within an image and (2) if inference for predicting change in images that are continuous in time series, wherein the metadata generating section generates the metadata based on information corresponding to time before and after the images have been acquired.

An image file generating method of a second aspect of the present invention generates an image file having training data candidates, and comprises inputting purpose information that has been designated, and generating metadata for designating that purpose of an inference model that will be created is for prediction, wherein, regarding generation of the metadata, at the time of creating an inference model in which images associated with image data are made training data candidates, when the purpose information that has been designated is prediction, metadata is generated with an earlier time as annotation information.

A server for providing training data, of a third aspect of the present invention, comprises, a reception circuit that receives image data and metadata relating to the image data, and a processor having a collecting section and a provision section, wherein the collecting section determines whether the metadata is (1) inference for detecting a physical object within an image, or is (2) inference for predicting change of images that are continuous in time series, and gathers image data by classifying in accordance with the result of determination, and the provision section provides image data that has been collected by the collecting section as a training data group.

### BRIEF DESCRIPTION OF THE DRAWINGS

FIG. 1A and FIG. 1B are block diagrams mainly showing the electrical structure of a learning request system of a first embodiment of the present invention, and in particular, FIG. 1A is a block diagram showing the electrical structure of a learning section and a learning request section, while FIG. 1B is a block diagram showing the electrical structure of a camera. It should be noted that FIG. 1A is a block diagram showing the electrical structure of a camera within a learning request system of a second embodiment.

FIG. 2 is a drawing showing generation of training data in the learning request system of the first embodiment of the present invention.

FIG. 3A and FIG. 3B are drawings for describing a method when selecting candidates for training data for learning, in the learning request system of the first and second embodiments of the present invention.

FIG. 4 is a drawing showing flow of generation of training data in the learning request system of the first and second embodiments of the present invention.

FIG. 5 is a table showing a relationship between training data and test data, in the learning request system of the first and second embodiments of the present invention.

FIG. 6 is a flowchart showing operation of the learning request system of the first and second embodiments of the present invention.

FIG. 7 is a flowchart showing operation of recreation of training data, in the learning request system of the first embodiment of the present invention.

FIG. 8A and FIG. 8B are flowcharts showing operation of a camera within the learning request system of one embodiment of the present invention.

FIG. 9 is a flowchart showing operation of a learning device within the learning request system of the first and second embodiments of the present invention.

FIG. 10 is a flowchart showing operation of an external unit (learning request device) within the learning request system of the first embodiment of the present invention.

FIG. 11 is a drawing showing correction processing of training data in the learning system of the first and second embodiments of the present invention.

FIG. 12 is a block diagram mainly showing the electrical structure of a camera within the learning request system of the second embodiment of the present invention.

FIG. 13 is a drawing showing generation of training data in the learning request system of the second embodiment of the present invention.

FIG. 14 is a drawing for describing a method when selecting candidates for training data for learning, in the learning request system of the second embodiment of the present invention.

FIG. 15 is a flowchart showing operation of recreation of training data, in the learning request system of the second embodiment of the present invention.

FIG. 16A to FIG. 16C are flowcharts showing operation of a camera within the learning request system of the second embodiment of the present invention.

FIG. 17 is a flowchart showing operation of an external unit (learning request device) within the learning request system of the second embodiment of the present invention.

FIG. 18A and FIG. 18B are drawings showing examples inferring a relationship between an image and a phenomenon occurring after that, in the learning system of the second embodiment of the present invention.

FIG. 19A and FIG. 19B are drawings showing examples of inferring photo opportunity from a relationship between an image and a phenomenon occurring after that, in the learning system of the second embodiment of the present invention.

FIG. 20A and FIG. 20B are flowcharts showing operation of a camera that is capable of inferring photo opportunity, in the learning system of the second embodiment of the present invention.

FIG. 21 is an explanatory drawing showing a modified example of specification setting menu display, in the first and second embodiments of the present invention.

FIG. 22 is a flowchart for describing operation of a learning request device 30 for performing specification setting menu display, in the first and second embodiments of the present invention.

### DETAILED DESCRIPTION OF THE PREFERRED EMBODIMENTS

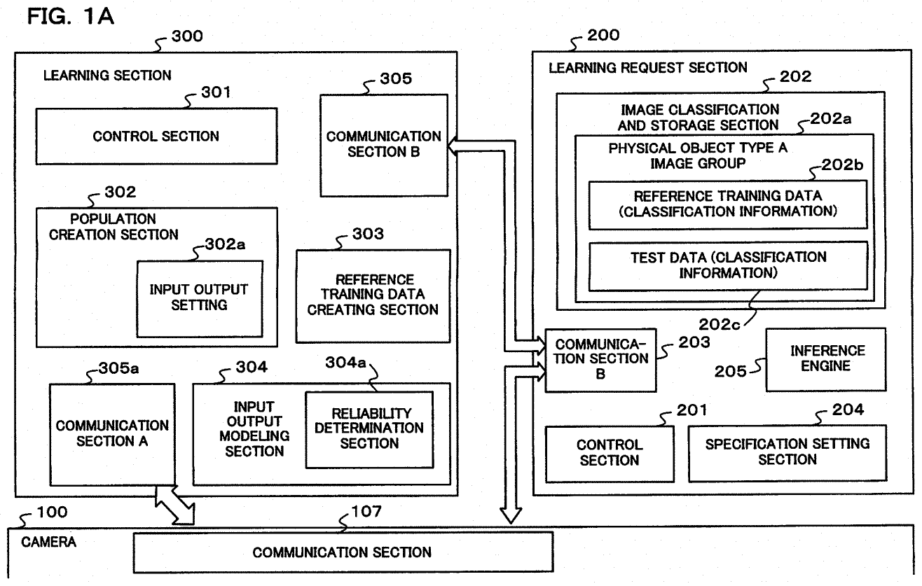

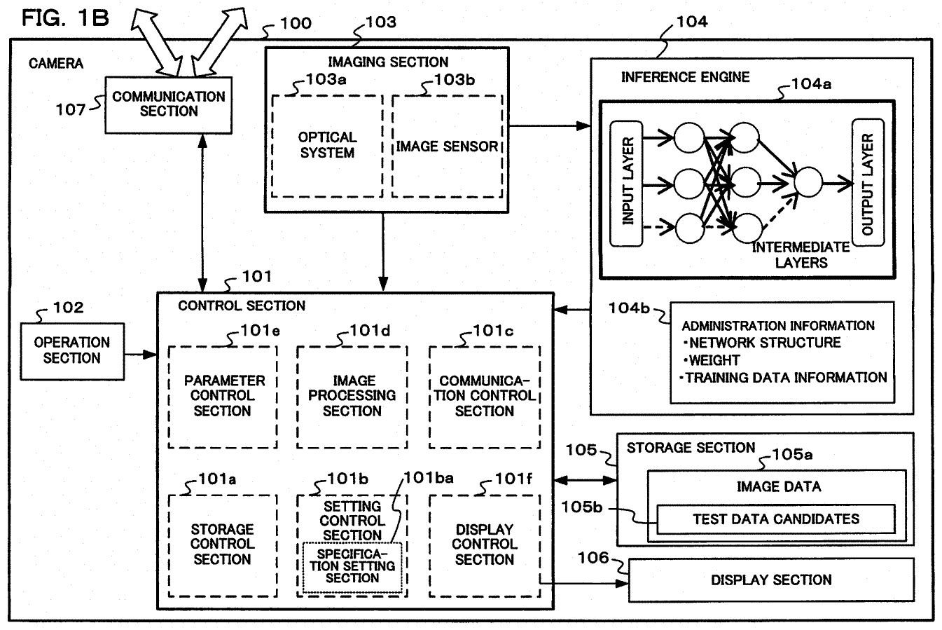

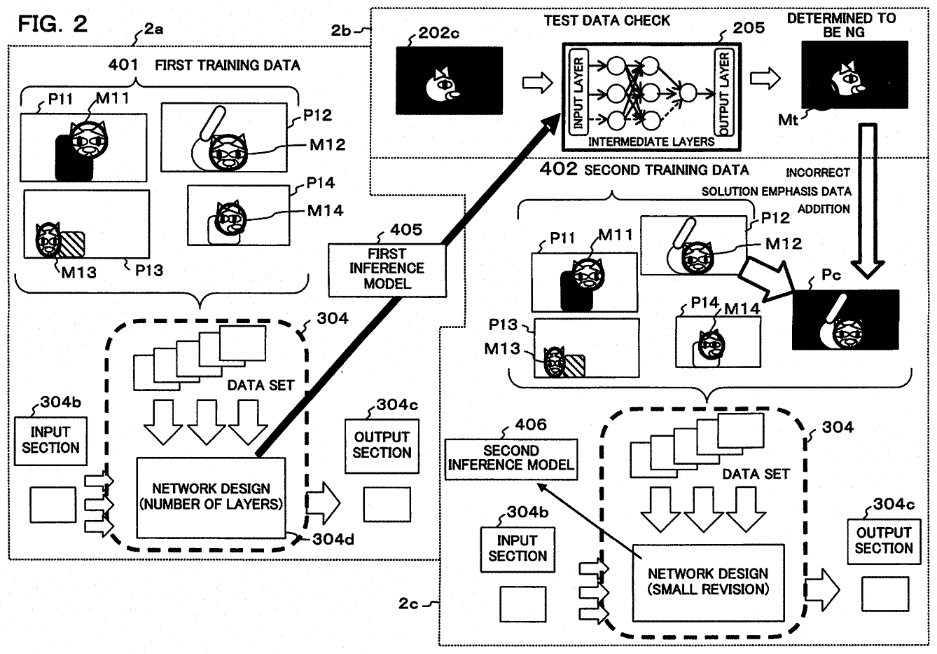

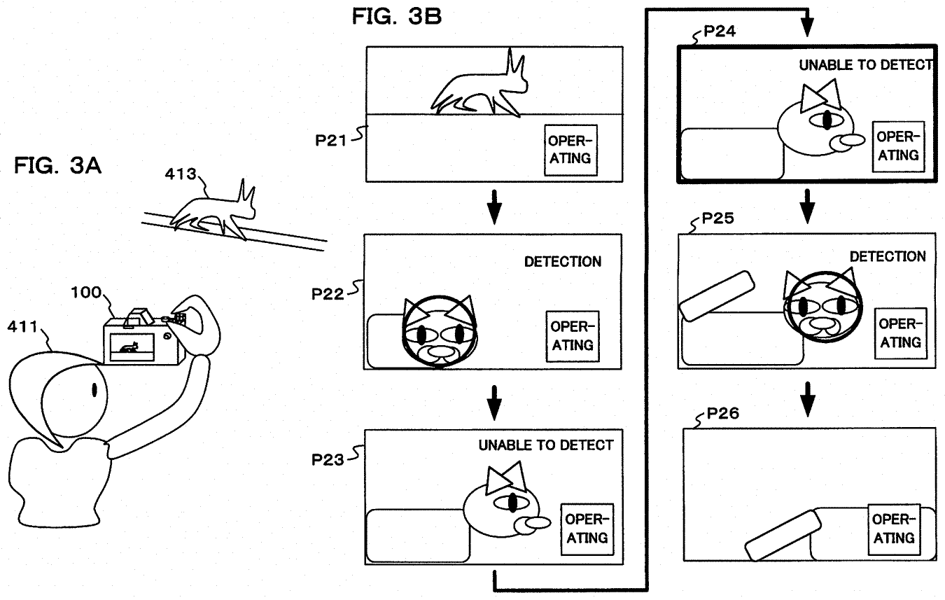

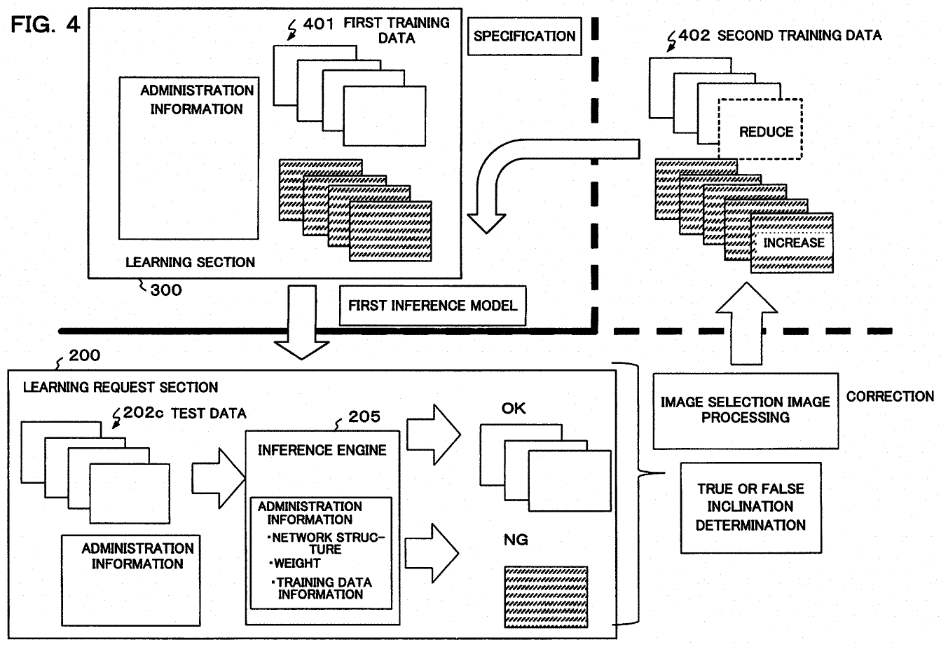

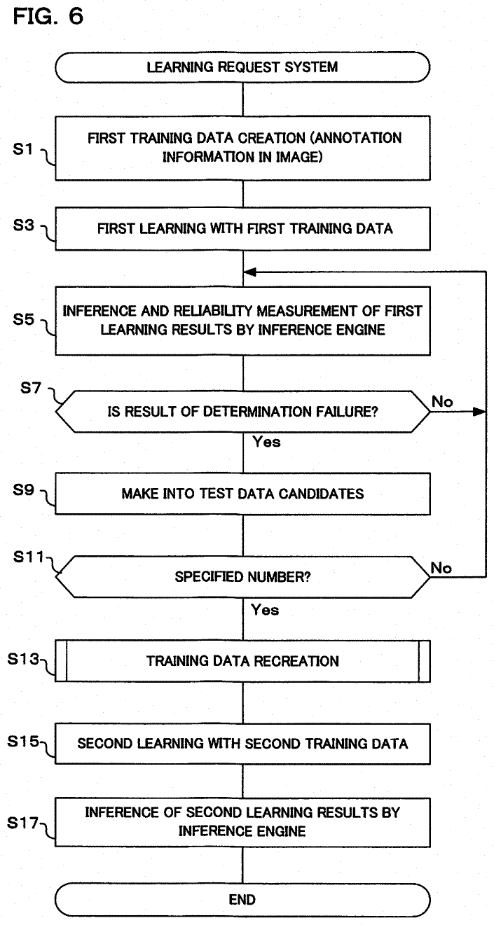

In the following, a learning request system comprising a camera, a learning section, and a learning request section will be described as a first embodiment of the present invention. The following is an overview of this embodiment. The learning section generates various inference models, for photographing support etc., using first training data (refer, for example, to S1 and S3 in FIG. 6). The camera can acquire image data using an imaging section. This camera has an inference engine, with inference for photographing support etc. being performed by the inference engine, and inference results displayed (refer, for example, to FIG. 3B and to S5 in FIG. 6). In the event that there is error detection at the time of display of this inference result, an image at this time (for example, image P24 in FIG. 3B) is stored as a test data candidate (refer, for example, to S9 in FIG. 6). The camera or the learning request section create second training data that will be used at the time of causing relearning in the learning section using test data candidates (refer, for example, to within frame 2c in FIG. 2, the second training data 402 in FIG. 4, and S13 in FIG. 6). In this way, it is possible to obtain inference results by setting an inference model that has been created by relearning using second training data in the inference engine (for example, the inference engine 104 in FIG. 1B), and inputting images. At the time of this inference, if input images are made similar specifications to training data, a function of assisting inference is increased.

FIG. 1A and FIG. 1B are block diagrams showing an overall learning request system of this embodiment. This learning request system comprises a camera 100, learning request section 200 and learning section 300.

In summary, the camera 100 is a so-called digital camera, and has an imaging section 103, with a subject image being converted to image data by this imaging section 103, and the subject image being subjected to live view display on a display section 106 arranged on the rear surface of the camera body based on this converted image data. A photographer determines composition and photo opportunity by looking at the live view display. If the user performs instruction for actual shooting (that is, operates the release button), image data that has been acquired by the imaging section 103 and subjected to image processing by an image processing section 101 is stored in a storage section 105. Image data that has been stored in the storage section 105 can be subjected to playback display on the display section 106 if the user selects playback mode.

Detailed structure of the camera 100 in FIG. 1B will now be described. The camera 100 comprises a control section 101, operation section 102, imaging section 103, inference engine 104, storage section 105, display section 106, and communication section 107.

The operation section 102 is an input interface for the user to command the camera. The operation section 102 has various operation members for input, such as a release button, various switches such as a power supply switch, various dials such as a mode setting dial for shooting mode setting, and a touch panel that is capable of touch operations, etc. Operating states of the operation members that have been detected by the operation section 102 are output to the control section 101.

The imaging section 103 has an optical system 103a and an image sensor 103b. The optical system 103a is an optical lens for forming an optical image of a subject, which is a photographed object, and has a focus lens and a zoom lens etc. The image sensor 103b subjects the optical image to photoelectric conversion and outputs an image signal. Besides this, the imaging section 103 has various circuits and elements such as am imaging control circuit, image signal processing circuit, aperture, and shutter etc. The image signal is converted to digital image data by the image signal processing circuit, and output to the control section 101 and inference engine 104.

The inference engine 104 stores inference models, and performs inference for image data that has been input from the imaging section 103 using inference models that have been stored. That is, the inference engine 104 outputs inference results that have been obtained with images as input, in other words, some new information (image judgment, detected content that is included in images, position of that detection, and other items). It should be noted that for images that are used as input to this inference model also, operations are performed on metadata, as described with this embodiment, and it is possible to support correct inference. Unless otherwise the images of this embodiment are considered applicable not only in a case where they are only used in candidates for training data, but also in a case of images that are input for inference. However, within this specification, in order to simplify the description, description will mainly be for a phase in which training data is created. An inference model that has been generated by the learning section 300, which will be described later, is input via the communication section 107, and stored. The inference engine 104 comprises network design 104a and administration information 104b.

The inference engine 104 functions as an inference section that, using a first inference model that has been learned using first training data made up of a first image group and annotation results of that first image group, performs inference on a second image group that is different from the first image group. The inference section performs inference using test data as second images (refer, for example, to test data Pt (202c) within frame 2b of FIG. 2, and test data 202c of FIG. 4). The inference engine 104 functions as an inference section that performs inference for second images that are not included in the first image group (refer, for example, to S5 in FIG. 6).

The network design 104a has intermediate layers (neurons) arranged between an input layer and an output layer. Image data that has been acquired by the imaging section 103 is input to the input layer. A number of layers of neurons are arranged as intermediate layers. The number of layers of neurons is appropriately determined according to the design, and a number of neurons in each layer is also determined appropriately in accordance with the design. Intermediate layers N are weighted based on an inference model that has been generated by the learning section 300. Image evaluation information is output at the output layer in accordance with images that have been input to the input layer. Deep learning will be described later together with configuration of an input output modeling section 304.

The administration information 104b is information that has been stored in memory within the inference engine 104. The administration information 104b includes network structure, weight, and training data information. Among these items of information, network structure is information for stipulating structure of neurons of the network design 104a. Weight is information relating to weighting of connections between respective neurons. Training data information is information relating to training data, such as training data generator, version information, information relating to data population that created the training data, etc. These items of the administration information 104b may be stored in other memory within the camera 100 other than memory within the inference engine 104.

The storage section 105 is an electrically rewritable non-volatile memory. Image data 105a that has been output from the imaging section 103 and subjected to image processing for storage by the image processing section 101d is stored in the storage section 105. This image data 105a is read out, and after having been subjected to image processing for playback display by the image processing section 101d is subjected to playback display on the display section 106.

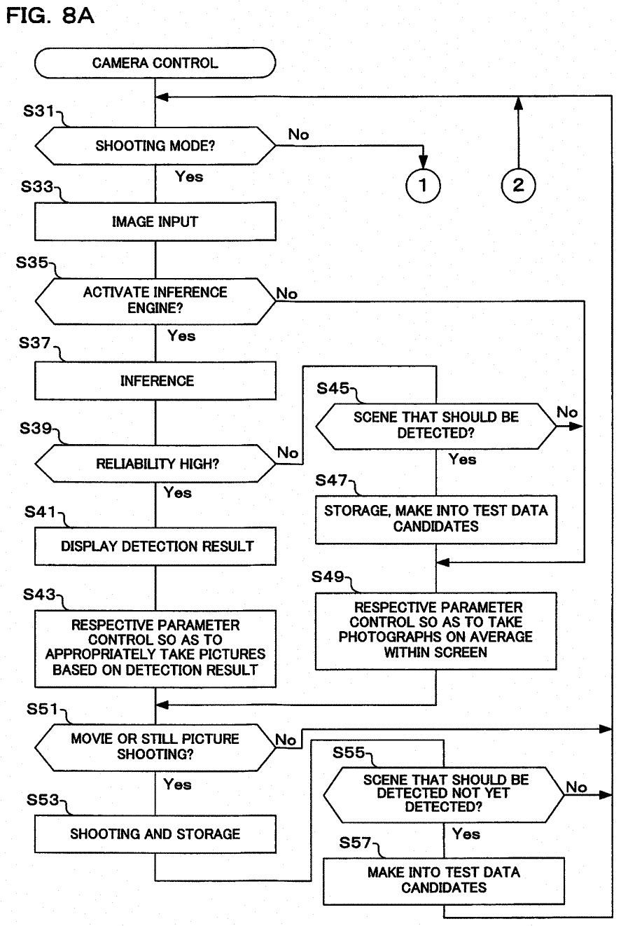

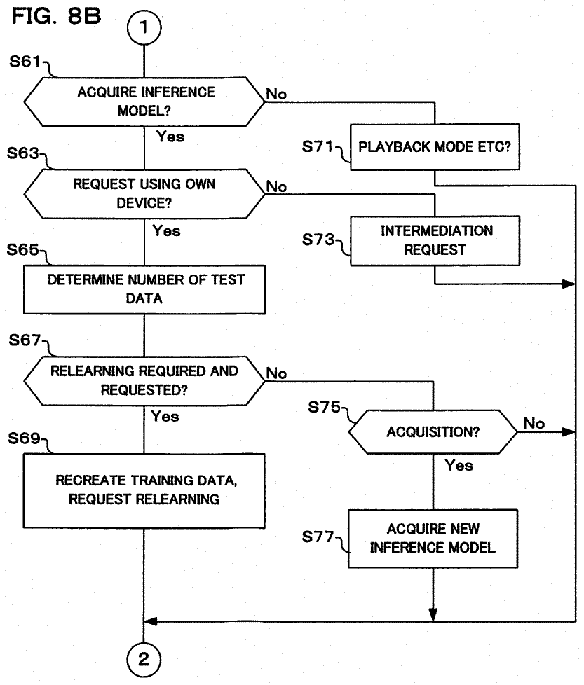

Also, the storage section 105 stores test data candidates in part of a storage region for the image data 105a. As will be described later, test data candidates 105b are image data that, after having generated an inference model, has been stored at the time appropriate inference was not performed, when inference was performed using this generated inference model (refer, for example, to image P24 in FIG. 3B, S9 in FIG. 6, and S47 and S57 in FIG. 8A).

The display section 106 has a display such as an LCD monitor or organic EL, and is arranged on the outside of the camera 100, or is an electronic viewfinder (EVF) that can be observed by means of an eyepiece. The display section 106 displays a live view image based on image data that has been acquired by the imaging section 103, and performs playback display of images that have been stored in the storage section 105. Also, the display section 106 displays inference results from the inference engine 104.

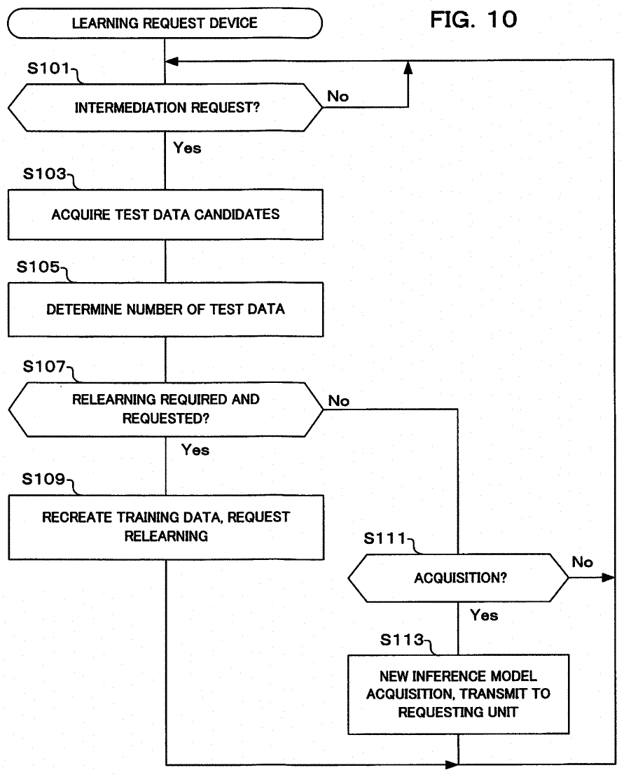

The communication section 107 has a communication circuit for performing transmission and reception. The communication section 107 can perform communication with a communication section B203 within the learning request section 200, and can perform communication with a communication section A305a within the learning section 300. The communication section 107 functions as a communication section that requests relearning, for generation of a second inference model based on second training data, to the learning device (refer, for example, to S69 in FIG. 8B and S109 in FIG. 10). The communication section 107 functions as a transmission section for transmitting a first image group, that is capable of having annotation results attached, to the learning device (refer, for example, to S1 in FIG. 6). The communication section B203 functions as a receiving section that receives a first inference model that has been learned using a first image group that has been subjected to annotation, from the learning device (refer, for example, to S3 and S5 in FIG. 6).

The control section 101 is a processor that is made up of an ASIC (application-specific integrated circuit) including a CPU (central processing unit) etc. and various peripheral circuits. The control section 101 comprises a storage control section 101a, a setting control section 101b, a communication control section 101c, an image processing section 101d, a parameter control section 101e, and a display control section 101f. Each of these sections is implemented using hardware circuits, and some parts are realized in accordance with a CPU and programs that have been stored in nonvolatile memory. Also, the processor is not limited to being one, and there may be a plurality of processors. The processor (control section), such as a CPU, functions as at least one processor having a correction section, request section, training data creating section, and re-learning request section, which will be described later. The control section 101 controls the whole of the camera 100 in accordance with the CPU and programs.

The control section 101 functions as a correction section that determines inference results of the inference section, and outputs correction information for correcting first training data (refer, for example, to generation of image Pc in FIG. 2, the correction in FIG. 4, and S13 in FIG. 6). The correction section increases or decreases image data that is contained in the first training data in accordance with the inference results, or performs image processing on the image data (refer, for example, to within frame 2b in FIG. 2, and to FIG. 4). Also, the control section 101 performs inference using a first inference model for image data that has been acquired by the imaging section, and makes the image data candidates for test data if inference results are error detection (refer, for example, to image P24 in FIG. 3B, and S9 in FIG. 6). Also, the control section 101 functions as a request section that creates second training data based on correction information, and requests relearning to generate an inference model based on this second training data (refer, for example, to S13 in FIG. 6, S69 in FIG. 8B, and S109 in FIG. 10).

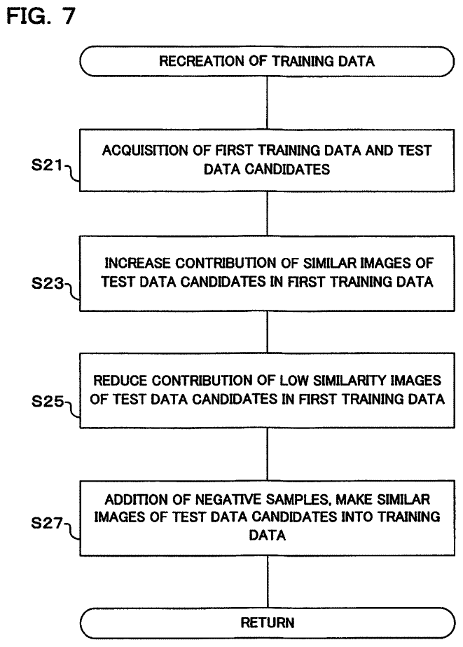

The control section 101 functions as a training data creating section that creates second training data based on error detection data at the time inference was performed using a first inference model that was generated based on first training data (refer, for example, to S7 and S9 in FIG. 6). The training data creating section increases or decreases image data that is included in first training data based on images at the time of error detection, or applies image processing to image data (refer, for example, to FIG. 2, FIG. 4 and FIG. 7). The control section 101 functions as a re-learning request section that requests relearning by transmitting correction information from a transmission sections to the learning device (refer, for example, to S15 in FIG. 6 and S69 in FIG. 8B). Also, the control section 101 functions as a re-learning request section that requests relearning by determining inference results of the inference section, and transmitting third images that are different to the first images and second image from the transmission section to the learning device, to acquire a second inference model that is different to the first inference model. For example, in FIG. 2, the first images correspond to the first training data 401, the second images correspond to the test data (202c), and the third images correspond to emphasis data Pc.

The storage control section 101a controls storage of image data etc. that is stored in the storage section 105. Specifically, storage of image data that has been acquired by the imaging section 103 and subjected to processing by the image processing section 101d is controlled. Also, in a case where results of inference by the inference engine 104 are not appropriate, test data candidates are stored in the storage section 105.

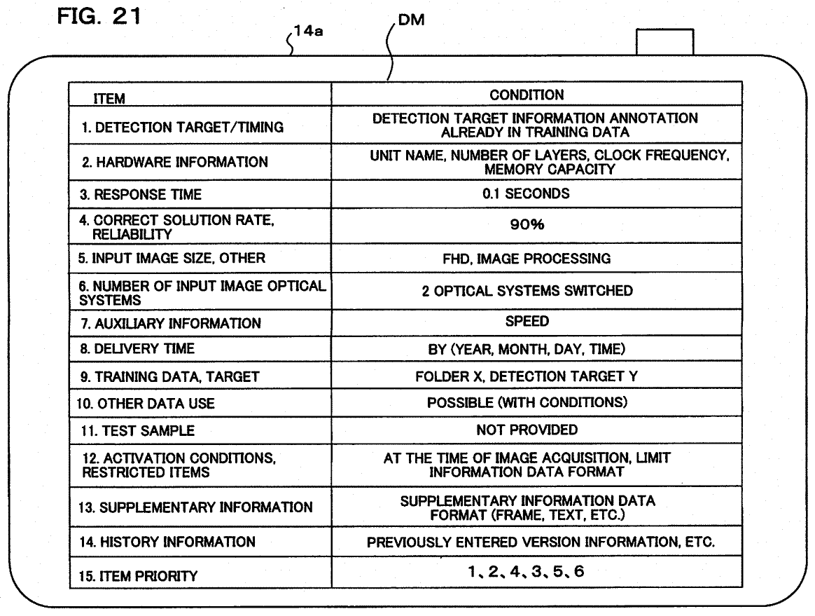

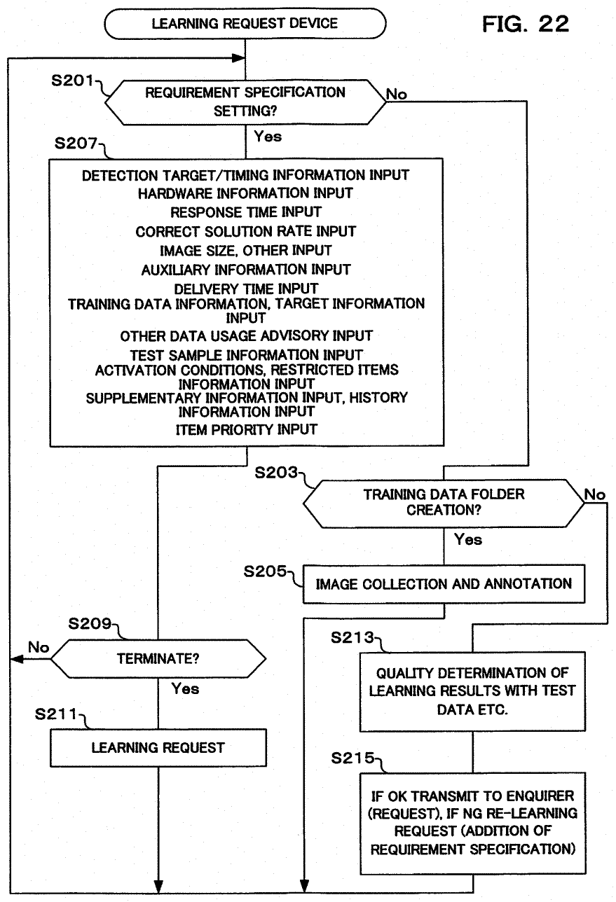

The setting control section 101b performs various settings of the camera 100. As various settings, settings such as of shooting mode, and setting of inference by the inference engine 104 is performed. Content of this inference that has been set is transmitted to the learning request section 200 or the learning section 300 as specifications. The setting control section 101b has a specification setting section 101ba, and sets specifications. As specifications, at the time taking a picture of a cat, for example, the eyes of the cat are focused on, and if the user wants advice such as to make the picture cute, if they input a request using the operation section 102 the specification setting section 101ba within the setting control section 101b performs setting so that it is possible to acquire an inference model that is suitable for the user to receive this advice. As specifications, for example, if there is a cat in an image, specification of an inference model may also be set so that it is possible to focus on the position of the eyes of the cat and take a cute photograph. Also, besides this, for example, desired delivery period (time) until an inference model is acquired, and inference time and power consumption etc. needed for inference may be set. Other specific examples of specification will be described later using FIG. 21 and FIG. 22.

The communication control section 101c performs control of communication by the communication section 107. The learning request section 200 and learning section 300 are capable of being connected by means of the Internet. The communication control section 101c sets transmission destination, information to be transmitted, information to be received etc. when performing communication with the learning request section 200 and the learning section 300 using the communication section 107.

The image processing section 101d has an image processing circuit, and performs various image processing on image data that has been acquired by the imaging section 103. For example, the image processing circuit applies various basic image processing, such as exposure correction and noise processing, WB gain correction, edge enhancement, false color correction etc. to image data. Further, the image processing circuit also performs processing (development processing to apply image processing for a live view image) to image data that has been subjected to the above described image processing, and to convert image data that has been subjected to the above described image processing to a stored data format etc. Further, display etc. is also performed based on inference results from the inference engine 104.

The parameter control section 101e has a parameter control circuit, and controls various parameters for performing shooting, for example, parameters such as aperture, shutter speed, ISO sensitivity, focal length etc.

The display control section 101f has a display control circuit, and performs control of display on the display section 106. Specifically, the display control section 101f controls display of images based on image data that has been processed by the image processing section 101d. Display control of menus screens etc. is also performed.

Next, the learning request section 200 shown in FIG. 1A will be described. The learning request section 200 is, for example, a server that is capable of connecting to the learning section 300 and camera 100 by means of the Internet. Also, a learning request section 200 may be arranged within the camera 100. The learning request section 200 comprises a control section 201, image classification and storage section 202, communication section B203 and specification setting section 204. This learning request section 200 has a database (image classification and storage section 202) for storing training data that has been created from image data that has been acquired by the camera 100, and requests inference, that uses reference training data 202b and test data 202c based on this image data that has been stored, to the learning section 300.

The image classification and storage section 202 has an electrically rewritable memory, and stores physical object type A image group 202a. The image classification and storage section 202 stores image data etc., by dividing physical objects into a plurality of classifications. In FIG. 1A, only physical object A is described as a classification, but the learning request section 200 may perform appropriate classification and classify and store a plurality of physical objects. Reference training data 202b and test data 202c are stored in the physical object type A image group 202a.

The reference training data 202b is training data for performing deep learning and creating an inference model. Training data is made up of image data, and information that has been attached to this image data using annotation. For example, when there is an image of a cat, information indicating that there is that cat, and position information of the eyes of the cat, are attached using annotation. By performing deep learning using these reference training data, if there is a cat in an image it is possible to generate an inference model that will locate position of the eyes of the cat. Classification information, such as cat, is added to this reference training data 202b.

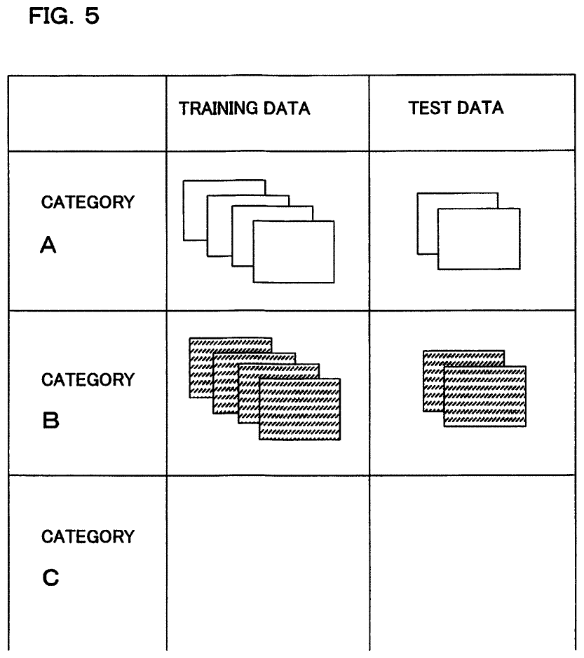

The test data 202c is training data used in order to detect reliability of an inference model that has been generated using reference training data. Regarding test data also, for example, if there is an inference model for locating the eyes of a cat, then similarly to the reference training data, if there is a cat in an image the test data is stored in association with information showing the position of the eyes of the cat. Specifically, training data is data that is used when the learning section 300 creates an inference model, while test data is data that is used when testing the inference model. As will be described later when the user takes photographs with the camera 100, test data may be created. Also, there may be test data that has been gathered uniquely by the learning request section 200, without being limited to images that have been taken by the user with the camera 100. Classification information, such as cat, may also be attached to this test data 202c. The relationship between training data and test data will be described later using FIG. 5.

The communication section B203 has a communication circuit (including a transmission circuit, reception circuit, etc.) for performed transmission and reception. The communication section B203 can perform communication with the communication section 107 within the camera 100, and can perform communication with a communication section B305b within the learning section 300. The communication section B203 functions as a communication section that requests relearning for generation of a second inference model based on second training data to the learning device (refer, for example, to S69 in FIG. 8B and S109 in FIG. 10). The communication section B203 functions as a transmission section for transmitting a first image group that is capable of having annotation results assigned, to the learning device (refer, for example, to S1 in FIG. 6). The communication section B203 functions as a receiving section that receives a first inference model that has been learned using a first image group that has been subjected to annotation, from the learning device (refer, for example, to S3 and S5 in FIG. 6).

At the time of requesting generation of an inference model using deep learning from the learning request section 200 to the learning section 300, the specification setting section 204 set specifications for that inference model. For example, if there is a cat in an image, specification of an inference model is set so that it is possible to focus on the position of the eyes of the cat and take a cute photograph. Also, as specifications, for example, desired delivery period (time) until an inference model is acquired, and inference time and power consumption etc. needed for inference, may be set. Other specific examples of specification will be described later using FIG. 21 and FIG. 22. The specification that has been set is transmitted to the learning section 300 by means of the communication section B203, and the learning section 300 generates an inference model on the basis of this specification.

It should be noted that an image does not necessarily have to be adopted as training data for this inference model, and may be selected depending on various restrictions at the time of learning, and the result. Although this image is an image that can be a candidate for training data and test data, it is still a candidate which may not be used for either data. Also, in a case where an inference model has been generated, an image having some of the specification information can be made suitable for inference by being used as an inference input. In a case where specification is set in the specification setting section 101ba within the camera 100, and mediation for inference model generation has been requested to the learning request section 200, specification from the camera 100 is transferred to the learning section 300. Also, regarding the specification setting section 204, that function may be held within the control section 201.

The inference engine 205 stores inference models, and performs inference for image data that has been input using inference models that have been stored. An inference model that has been generated by the learning section 300, which will be described later, is input via the communication section B305b, and stored. The inference engine 205, similarly to the inference engine 104, has network design, and may store administration information that is similar to the administration information 104b. The inference engine 205 may also have a reliability determination section, similar to the reliability determination section 304a within the input output modeling section 304.

The inference engine 205 functions as an inference section that, using a first inference model that has been learned using first training data made up of a first image group and annotation results of that first image group, performs inference on a second image group that is different from the first image group (refer, for example, to within frame 2b in FIG. 2, and to the inference engine of FIG. 4). The inference section performs inference using test data as second images (refer, for example, to test data Pt (202c) within frame 2b of FIG. 2, and test data 202c of FIG. 4). The inference engine 205 functions as an inference section that performs inference for second images that are not included in the first image group (refer, for example, to S5 in FIG. 6).

The network design within the inference engine 205 has intermediate layers (neurons) arranged between an input layer and an output layer, similarly to the network design 104a. Image data is input to the input layer. A number of layers of neurons are arranged as intermediate layers. The number of layers of neurons is appropriately determined according to the design, and a number of neurons in each layer is also determined appropriately in accordance with the design. Intermediate layers are weighted based on an inference model that has been generated by the learning section 300. Image evaluation information is output at the output layer in accordance with images that have been input to the input layer. Deep learning will be described together with configuration of an input output modeling section 304.

The control section 201 is a processor that is made up of an ASIC (application-specific integrated circuit) including a CPU (central processing unit) etc. and various peripheral circuits. The control section 201 controls the whole of the learning request section 200 in accordance with the CPU and programs. It should be noted that the specification setting section 204 may be implemented by the CPU within the control section 201 and programs, and may also have various functions such as a communication control section etc. for controlling the communication section B203 etc. The processor is not limited to being one, and there may be a plurality of processors. The processor (control section), such as a CPU, functions as at least one processor having a correction section, request section, training data creating section, and re-learning request section, which will be described later.

The control section 201 functions as a correction section that determines inference results of the inference section, and outputs correction information for correcting first training data (refer to generation of image Pc in FIG. 2, the correction in FIG. 4, and S13 in FIG. 6). The correction section increases or decreases image data that is contained in the first training data in accordance with the inference results, or performs image processing on the image data (refer, for example, to within frame 2b in FIG. 2, and to FIG. 4). The control section 201 performs inference using a first inference model for image data that has been acquired by the imaging section, and makes the image data candidates for test data if the inference results in error detection (refer, for example, to image P24 in FIG. 3B, and S9 in FIG. 6). Also, the control section 201 functions as a request section that creates second training data based on correction information, and requests relearning to generate an inference model based on this second training data (refer, for example, to S13 in FIG. 6, S69 in FIG. 8B, and S109 in FIG. 10).

The control section 201 functions as a training data creating section that creates second training data based on error detection data at the time inference was performed using a first inference model that was generated based on first training data (refer, for example, to S7 and S9 in FIG. 6). The training data creating section increases or decreases image data that is included in first training data based on images at the time of error detection, or applies image processing to image data (refer, for example, to FIG. 2, FIG. 4 and FIG. 7). The control section 201 functions as a re-learning request section that requests relearning by transmitting correction information from a transmission sections to the learning device (refer, for example, to S15 in FIG. 6 and S109 in FIG. 10).

Also, the control section 201 functions as a re-learning request section that requests relearning by determining inference results of the inference section, and transmitting third images that are different to the first images and second image from the transmission section to the learning device, to acquire a second inference model that is different to the first inference model. For example, in FIG. 2, the first images correspond to the first training data 401, the second images correspond to the test data (202c), and the third images correspond to emphasis data Pc.

Next, the learning section 300 will be described. The learning section 300 is a server that is capable of connecting to the learning request section 200 and the camera 100 etc. by means of the Internet, and receives requests from outside, such the camera 100 and learning request section 200 etc., to generate an inference model. The learning section 300 comprises a control section 301, a population creation section 302, a reference training data storage section 303, an input output modeling section 304, a communication section A305a and a communication section B305b. This learning section 300 generates an inference model using training data, in accordance with specifications that have been requested from the camera 100 or the learning request section 200. This inference model that has been generated is transmitted to an external device (learning request section 200, camera 100) by means of the communication section A305a and communication section B305b.

The reference training data storage section 303 has an electrically rewritable non-volatile memory, and stores reference training data 202b that has been transmitted from the learning request section 200. Also, in a case where training data has been created by the camera 100, this training data is stored (refer to S69 in FIG. 8B). As will be described later, in the event that generation of an inference model is being requested from the camera 100 or learning request section 200, when the population creation section 302 generates training data (data for learning), training data is created by including reference training data, or training data is created with reference to training data.

The population creation section 302 creates a population (training data, data for learning) for performing deep learning. The population creation section 302 may create training data constituting a population from a database in a hardware manner using the processor within the control section 301, and may also create training data constituting a population from a database in a software manner using the processor within the control section 301. The population creation section 302 creates training data for deep learning using image data that can be used in deep learning within the learning section 300 and image data that has been accumulated in other servers etc. As was described previously, in a case where the generation of an inference model is being requested from the camera 100 or the learning request section 200, the population creation section 302 creates a population (training data) for deep learning by including reference training data that is stored in the reference training data storage section 303, or with reference to reference training data. Training data has information of the input output setting section 302a attached. Specifically, training data has data that is input at the time of deep learning, and output results (correct solution) set in advance.

The input output modeling section 304 has a machine learning processor, and performs deep learning using so-called artificial intelligence (AI) to generate an inference model. Specifically, using an image data population that has been created by the population creation section 302, the input output modeling section 304 generates inference models by deep learning. Deep learning is a function approximator that is capable of learning relationships between inputs and outputs.

The input output modeling section 304 has the same structure as the network design 104a of the inference engine 104. Image data that has been created by the population creation section 302 is input to the input layer. Also, evaluation results for images, for example, training data (correct solution) are provided to the output layer. An inference model is generated by calculating strength (weight) of connection between each neuron within the network design, so that the input and output match. It should be noted that with this embodiment, the input output modeling section 304 generates an inference model using deep learning, but this is not limiting and it may use machine learning. Also, the input output modeling section 304 may also generate an inference model in a software manner using the processor within the control section 301, and not hardware circuits such as the network design.

Also, the input output modeling section 304 has a reliability determination section 304a. The reliability determination section 304a determines reliability of the inference model that has been generated by the input output modeling section 304. Determination of reliability is performed, for example, by calculating a LOSS value etc. A LOSS value is a difference between an inference result with an inference model that has been generated by deep learning and a previously known solution in a case where deep learning has been performed with an exercise that has been previously solved (for example, OK or NG at the time of insertion).

Next, deep learning will be described. “Deep Learning” involves making processes of “machine learning” using a neural network into a multilayer structure. This can be exemplified by a “feedforward neural network” that performs determination by feeding information forward. The simplest example of a feedforward neural network should have three layers, namely an input layer constituted by neurons numbering N1, an intermediate later constituted by neurons numbering N2 provided as a parameter, and an output later constituted by neurons numbering N3 corresponding to a number of classes to be determined. Each of the neurons of the input layer and intermediate layer, and of the intermediate layer and the output layer, are respectively connected with a connection weight, and the intermediate layer and the output layer can easily form a logic gate by having a bias value added.

While a neural network may have three layers if simple determination is performed, by increasing the number of intermediate layers it becomes possible to also learn ways of combining a plurality of feature weights in processes of machine learning. In recent years, neural networks of from 9 layers to 15 layers have become practical from the perspective of time taken for learning, determination accuracy, and energy consumption. Also, processing called “convolution” is performed to reduce image feature amount, and it is possible to utilize a “convolution type neural network” that operates with minimal processing and has strong pattern recognition. It is also possible to utilize a “Recurrent Neural Network” (Fully Connected Recurrent Neural Network) that handles more complicated information, and with which information flows bidirectionally in response to information analysis that changes implication depending on order and sequence.

In order to realize these techniques, it is possible to use conventional general-purpose computational processing circuits, such as a CPU or FPGA (Field Programmable Gate Array). However, this is not limiting, and since a lot of processing of a neural network is matrix multiplication, it is also possible to use a processor called a GPU (Graphic Processing Unit) or a Tensor Processing Unit (TPU) that are specific to matrix calculations. In recent years a “neural network processing unit (NPU) for this type of artificial intelligence (AI) dedicated hardware has been designed to be capable being integratedly incorporated together with other circuits such as a CPU, and there are also cases where such a neural network processing unit constitutes apart of processing circuits.

Besides this, as methods for machine learning there are, for example, methods called support vector machines, and support vector regression. Learning here is also to calculate identification circuit weights, filter coefficients, and offsets, and besides this, is also a method that uses logistic regression processing. In a case where something is determined in a machine, it is necessary for a human being to teach the machine how determination is made. With this embodiment, a method of deriving determination of an image by using machine learning is adopted, and besides this may also use a rule-based method that accommodates rules that a human being has experimentally and heuristically acquired.

The communication section A305a and the communication section B305b have communication circuits that perform common transmission and reception. The communication section A305a can perform communication with the communication section 107 within the camera 100. The communication section B305b can perform communication with the communication section B203 within the learning request section 200.

The control section 301 is a processor that is made up of an ASIC (application-specific integrated circuit) including a CPU (central processing unit) etc. and various peripheral circuits. The control section 301 controls the whole of the learning section 300 in accordance with the CPU and programs. It should be noted that the population creation section 302 and the input output modeling section 304 may be implemented by the CPU within the control section 301 and programs, and may also have various functions such as a communication control section etc. for controlling the communication section A305a, communication section B305b etc.

Next, the data for learning (training data) used in the deep learning of this embodiment will be described using FIG. 2. A process for generating an inference model of the network design, using first training data, is shown within the frame 2a of FIG. 2. This inference model generation is performed in the learning section 300 shown in FIG. 1A. The inference model is generated using the first training data 401 that was created in the population creation section 302. The first training data 401 is made up of images P11 to P14, and information indicating position of the eyes of the cat in those images (shown in the drawing by balloons M11 to M14). It should be noted that many images are actually used as the first training data 401, but in FIG. 2 four images are shown by way of example.

The learning section 300 uses the first training data 401 as data for learning for deep learning, and generates an inference model using the input output modeling section 304. Image data P11 to P14 (image data having M11 to M14 showing position of a cat's eyes deleted) within the first training data 401 is input to the input section 30 of the network design 304d within the input output modeling section 304. Also, information indicating position of the eyes of the cat (M11 to M14) are supplied to the output section 304c. The network design 304d generates a first inference model 405 by calculating strengths (weights) of connections between each neuron within the network design 304d so that information showing position of a cat's eyes (M11 to M14) is output when image data P11 to P14 within the first training data 401 is input.

If the first inference model 405 is generated in the input output modeling section 304, this first inference model 405 is transmitted to the inference engine 205 within the learning request section 200 shown within frame 2b in FIG. 2. The inference engine 205 is input with test data 202c, while setting this first inference model 405 that has been received in the network design. The inference model that has been received can infer a position of a cat's eyes, but with the example shown within frame 2b in FIG. 2, information Mt showing position of a cat's eyes shows position of a cat's shoulder, and failure is set for inference (NG). This is because the image of the test data 202c was dark. Specifically, this is because there are no dark images of cats in the first training data 401, and deep learning was not performed using this type of image.

The control section 201 within the learning request section 200 therefore creates images of cats (emphasis data) Pc in a dark state by correcting images of cats in the first training data, as shown within the frame 2c in FIG. 2. The learning request section 200 transmits the image data Pc of the cat that has been corrected to the learning section 300, and the learning section 300 stores the image data Pc that has been received in the reference training data storage section 303. The input output modeling section 304 within the learning section 300 performs inference using second training data that has the image Pc added to the first training data, and generates a second inference model 406. This second inference model is an inference model that has made a small revision to the network design 304d, and can infer position of eyes even if there is a dark image of a cat. Relearning is requested to the learning section 300 so as to generate an inference model using this second training data ‘refer, for example, to S69 in FIG. 8B, and S109 in FIG. 10).

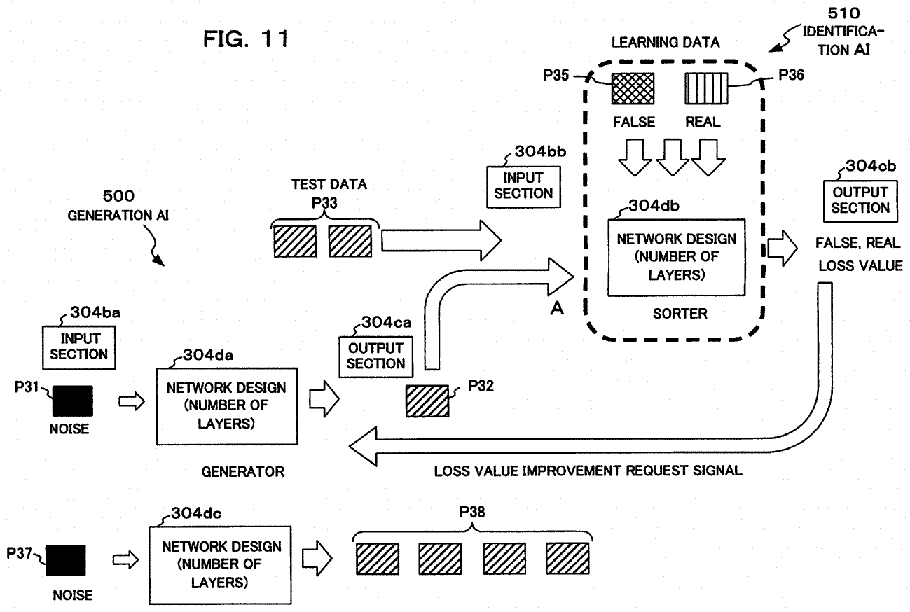

It should be noted that in the description of the processing for within frame 2b in FIG. 2, checking of the inference model was performed using test data in the learning request section 200, and second training data was created. However, checking of the inference model using test data may be similarly performed in the camera 100, and the second training data created. Also, other than correcting images of the first training data using normal image processing, images that are similar to the images of the first training data may also be created using GAN (Generative Adversarial network). Generating images using GAN will be described later using FIG. 11.

Next, one example of acquisition of test data candidates will be described using FIG. 3A and FIG. 3B. With the method shown in FIG. 3A and FIG. 3B, images among the test data 202c, that fail to obtain expected inference results on shooting with the camera 100 having the inference engine 104 installed, are taken as test data candidates (refer, for example, to S5, S7 and S9 in FIG. 6). A camera, as an image file generating device that generates an image file comprising training data candidates, can make images acquired at the time of shooting training data, and can generate metadata for designating whether an inference model that will be learned using that training data is (1) inference to detect a physical object within an image, or (2) inference to predict change in images that are continuous in time series. Here, an example of inference for detection is shown. Also, in order to be able to use acquired images in inference for detection as training data and test data, with this embodiment a processor that has a metadata generating section that is capable of classifying images is provided (for example, the control section 101). The metadata generating section determines metadata based on information corresponding to time before and after the images have been acquired. Here, since a case where detection is possible and a case where detection is not possible are close in time, it becomes possible to set images for which detection was not possible as candidates for training data and test data that will improve inference for detection. At this time, it may also be determined whether or not those images should have been detected (applicability as training data) by judging image features, such as change in color and change in angle of view.

FIG. 3A show appearance of the user 411 taking a picture of a photographed object 413 (a cat in this case) using the camera 100. FIG. 3B shows images P21 to P26 that have been taken by the user 411 using the camera 100, in time sequence. An inference model that can infer position of a cat's eyes (the first inference model 405 with the examples of FIG. 2) is set in the inference engine 104 of the camera 100. “operating” that is displayed at the lower right corner of the images P21 to P26 shows that inference using the inference engine is being performed. “detected” or “could not detect” displayed in the lower right corner of images P21 to P24 shows that it was possible, or not possible, to detect a “cat's eye” using inference. Also, balloons that are drawn superimposed on positions of the cat's eyes show positions of the eyes that have been estimated using the inference engine 104.

Image P21 is an initial image of the photographing object (cat) 413 that has been taken by the user 411. In this image P21, the inference engine 104 cannot detect an eye. In image P22 that was taken after image P21 the cat is facing in the direction of the camera 100, and so it is possible to detect position of the eyes. In this case, position of the eyes is displayed with the balloon, and the fact that “detection” was possible is displayed.

In image P23 that was taken after image P22, the cat is now facing sideways, and is at a position where an eye can be seen. However, it is not possible to detect position of the eyes by inference using the inference engine 104. Further, in image P24 that was taken next also, although the cat is at the position where an eye can be seen, it is not possible to detect position of the eyes by inference using the inference engine 104. However, in image P25 that was taken after image P24 the cat now faces towards the front, and the inference engine 104 can detect position of the eyes. In this way, in a case with image P23 and image P24 failing to infer position of the eyes, there is a possibility that it just so happened to fail in detection using inference in image P23, but detection failed successively in image P24 as well. Image P24 that was taken immediately before image P25, in which it was possible to detect position of the eyes, is therefore stored in the storage section 105 as a test data candidate. The final image P26 no longer has the eyes of the cats, and position of the eyes cannot be inferred.

In this way, the user shoots a photographed scene for which the same result as that of the first inference model 405 that was generated using the first training data 401 is expected. Then, images that have a different detection result to the inference results using the first inference model (image P24 in the example shown in FIG. 3B) are stored as test data candidates. The learning request section 200 checks first inference data with this image as test data (refer to S7 and S9 in FIG. 6, which will be described later). Also, it is possible to increase training data (learning data) for improving the first inference model, from image data (log data) that was photographed using the camera 100.

Next, one example of a method for generating second training data from first training data will be described using FIG. 4. The learning section 300 depicted at the upper left of FIG. 4 generates a first inference model using first training data 401, in accordance with a specification. A specification represents inference purpose and conditions etc. for creating an inference model, that has been set by the specification setting section 204 of the learning request section 200, or by the specification setting section 101ba of the camera 100. Administration information is information for when generating the first inference model, and comprises various information such as, for example, creator of the first inference model (organization, company, etc.), version information, creation date, training data at the time of creation, etc. Also, management may be performed using the administration information so that images that require attention to be paid with regard to handling are not used or disseminated. Further, it may be made possible for the administration information to be handled with requests for removal of particular images etc., and administer handling etc. of individual information etc. may also be managed as a batch.

If a first inference model has been generated by the learning section 300, the first inference model is transmitted to the learning request section 200 and set in the inference engine 205. Network structure, weights, and training data information are stored in this inference engine 205 as administration information. Test data 202c is input to an input section of the inference engine 205. Test data may be chosen from among test data candidates that have been gathered by the method that was shown in FIG. 3B, and may also be gathered by another method. There are a plurality of test data 202c, and correct solutions, as a result of subjecting test data candidates to annotation and inference, that are stored in advance in association with test data 202c. In FIG. 4, the description “OK” means that a correct solution stored in the test data 202c and a result of inference match, while NG means that the inference result and the correct solution do not match.

If determination of inference results for the first inference model has been performed in the learning request section 200 using the test data 202c, next, the control section 201 of the learning request section 200 performs true or false tendency determination. Here, it is determined for what type of situation the first inference model fails inference, and for what type of situation the inference is correct. For example, with the example such as shown in FIG. 2 and FIG. 3B, it can be considered that there are a lot of errors for images that have been taken in a dark environment etc., and for images having the photographed object facing sideways. It can also be considered that there is tendency for inference to result in OK (correct) for images that have been taken in a bright environment and for images having the photographed object facing to the front.

If true or false tendency determination has been performed, next selection of images is performed and then the images are subjected to correction such as image processing, etc. For images that have an inclination towards being inferred as false, in the true or false tendency determination, those types of images are increased, and these increased images may be added to the training data. On the other hand, for images that have an inclination towards being inferred true in the true or false tendency determination, even if those types of images are reduced there is a possibility of inference being possible, and so thinning from training data is performed. Also, corrected image Pc, as shown in FIG. 2, may be generated from training images using image processing. The second training data 402 is generated by performing correction processing as was described above to the first training data. The true or false tendency determination, and correction processing, are performed in the learning request section 200 to generate second training data.

That is, the learning request section 200 receives a first inference model that was learned using first training data (data which is images having annotation information that has been annotated by assuming both cases of being annotated in the learning request section 200 and in the learning section 300) from the learning device using the communication section B203 (receiving section). In order to verify these learning results the learning request section 200 has an inference section that performs inference on second images that are not included in the first image group. As a result, it becomes possible to confirm specification and performance of an inference model that could not be defined by only the first training data. The inference results of an inference section for this performance determination are determined, and then the first training data is corrected, and relearning is requested by transmitting third images, that are different to the first images and second images from a transmission section to the learning device. Using this processing it is possible to acquire a second inference model that is different to the first inference model that satisfies specification and performance of an inference model that it was not possible to optimize using only training data that was initially assumed. Specifically, customizing and tuning an inference model are facilitated by further providing a learning request device having a re-learning request section that is capable of relearning what the user wants based on a general inference model that uses general training data. Training data that includes results of having corrected some of this first training data, and the third images, is made second training data.

However, this is not limiting, the second training data may also be generated in the camera 100. The training images may also be increased using a GAN (Generative Adversarial network). A method for creating images using GAN will be described later using FIG. 11.

Next, the training data and test data will be described using FIG. 5. As was described previously, training data is data for learning that is used when generating an inference model. Also, test data is data for verifying performance (reliability) of this inference model after the inference model has been generated. As shown in FIG. 1A, the image classification and storage section 202 stores physical objects by categorizing into groups, such as an A image group. This classification is performed by suitably partitioning photographed objects such as images of cats, images of dogs, images of birds, images of roses, images of chrysanthemum and so forth.

This classification (category) is used to create training data, at the time the input output modeling section 304 of the learning section 300 generates the inference model. Since the inference engine 205 of the learning request section 200 tests the inference model that has been generated by the input output modeling section 304, it is preferable to respectively associate training data and test data by classification (category). Specifically, as shown in FIG. 5, training data and test data of category A are associated, training data and test data of category B are associated, and training data and test data of category C are associated.

It is better if there is a lot of training data corresponding to various scenes, but there may be cases where, at the time of performing inference model creation, sufficient data has not been gathered. For example, when a person issuing a learning request for an inference model requests data gathering, since only images to hand will be insufficient, there may be cases where learning is performed using images other than those to hand. Further, a user who is sensitive to their own copyright and portrait rights may not wish to request learning using images they have to hand to a third party. There are therefore many cases where learning is requested that meets the user's own particular needs, using an image group that has been distributed or accumulated, other than images they have to hand.

However, ultimately, in specified scenes that the user themselves has assumed, results of images to hand (images that have been taken, images that the user attempted to take, etc.) are examined and judged. Even if a determination result is unsatisfactory, there is a high possibility that re-learning or retuning is requested without revealing images outside other than images to hand from the view point of portrait rights, copyright, security including the risk of data scarcity and falsification etc. and protection of individual information, and protection of know-how. There tend to be similar request conditions required regardless of whether the user is an individual or a company. Also, at the side receiving a request, there is a tendency to be reluctant to use images that have a problem of individual information or confidentiality. Accordingly, for images other than those that are at hand also, in order to easily obtain a specific inference model from specific scenes that have been assumed, there is a need for a system that is capable of simple customizing and tuning.

Next, overall operation of the learning request system shown in FIG. 1A and FIG. 1B will be described using the flowcharts shown in FIG. 6 and FIG. 7. This flow is implemented by controlling the system overall by cooperative operation of the control section 101, control section 201, and control section 301. However, this is not limiting, and implementation may also be performed with a single unit, may be performed with any two units, and may be performed in cooperation with yet another unit (a fourth unit). In many cases people and devices that will use first learning, second learning, and an inference engine will be different.

If the flow of the learning request system show in FIG. 6 is commenced, then first, first training data is created (S1). In this step, the population creation section 302 of the learning section 300 creates first training data. When creating this first training data, specifications of an inference model for which generation is requested to the learning section 300 is transmitted from the specification setting section 204 of the learning request section 200 (or the specification setting section 101ba of the camera 100). In a case where reference training data 202b (first image group) that is stored within the learning request section 200 is also transmitted, reference training data is stored in the reference training data storage section 303 within the learning section 300. The population creation section 302 creates a population (first training data) for an inference model based on the request (specification) from the learning request section 200. At this time, reference training data 202b may also be included, and first training data may also be created by gathering similar data with reference to the reference training data 202b. Since the first training data is used in deep learning, image data that is input to an input section, and correct solutions of inference results, are included. Specifically, correct solution information for inferences are associated with the first training data by performing annotation on images. This first training data corresponds to the first training data 401 shown within frame 2a in FIG. 2, and in FIG. 4.

Once the first training data is created, next first learning is executed using the first training data (S3). In this step, the input output modeling section 304 of the learning device 300 performs deep learning using the first training data that was created in step S1, and generates a first inference model. With the example shown within frame 2a in FIG. 2 and in FIG. 4, the network design 304d corresponds to performing deep learning using the first training data, and outputting of the first inference model 405.

If first learning has been performed using the first training data, next inference is performed by the inference engine using first learning results, reliability is measured (S5), and it is determined whether or not a result of determination is failure (S7). As was described above, if the first inference model is generated by the input output modeling section 304 within the learning device 300 the first inference model is transmitted to the camera 100. The inference engine 104 within the camera 100 sets a first inference model and performs inference. At the time of this inference, image data that has been acquired by the imaging section 103 is supplied to the input section of the inference engine 104. Result of this inference is displayed on the display section 106 of the camera 100 (refer to FIG. 3B), the user determines whether or not the inference result is correct, and if the inference result is not correct that image data is made a test data candidate (refer to image P24 in FIG. 3B). If the result of determination in step S7 is not failure, processing returns to step S5, and determination of inference and reliability is performed using the next test data. Also, if sample test data is stored in the inference engine 205 of the learning request section 200, inference may be performed in the learning request section 200 by the inference engine 205 using first learning results, and reliability may be measured.

If the result of determination in step S7 is failure, test data is made into a candidate (S9). Specifically, with the first inference model that was generated using first training data, there is a failure in inference. Therefore, the control section 101 of the camera 100 or the control section 201 of the learning request section 200 makes this image data that failed a test data candidate in order to generate a second inference model by having corrected the first inference model.

Next, it is determined whether or not a number of items of test data candidate data has reached a specified number (S11). In a case where a number of test data that have been made candidates is small, the need for relearning is lowered, and it is not possible to create second training data. Therefore, the control section 101 of the camera 100 of the control section 201 of the learning request section 200 determines whether or not there is enough second training data to make relearning necessary, and whether or not sufficient test data candidates for creating second training data have been collected. If the result of this determination is that the number of candidates has not reached a specified number, processing returns to step S5, and first learning is performed using the next data.

If the result of determination in step S11 is that test data candidates have reached a specified number, next training data is re-created (S13). Recreation of training data involves the camera 100 or the control section 201 of the learning request section 200 creating second training data using the test data that was made into candidates in step S9. In a case where the learning request section 200 performs recreation of the training data, the camera 100 transmits candidates for test data to the learning request section 200. This second training data corresponds to the second training data 402 within frame 2b in FIG. 2, or the second training data 402 of FIG. 4. The training data is not simply image data, and information relating to correct solution at the time of having performed inference must be associated with image data. This operation of associating information with image data is called annotation. Detailed operation of this recreation of training data will be described later using FIG. 7.

If training data has been recreated, next, second learning is performed using second training data (S15). If the camera 100 or the learning request section 200 has recreated training data as second training data, this second training data is transmitted to the learning section 300. The input output modeling section 304 performs second learning (deep learning) using this second training data that has been input, and generates a second inference model. It should be noted that the population creation section 302 creates a population for second learning using the second training data, and the input output modeling section 304 may perform second learning using this population.

If the learning section 300 has generated the second inference model, inference is performed by the inference engine using the second learning result (S17). Here, the learning section 300 transmits the second inference model to the camera 100. The camera 100 sets the second inference model that has been received in the inference engine 104, and performs inference on images that have been acquired by the imaging section 103. Once inference has been performed, this flow is terminated.

In this way, the learning request system first creates first training data, and then generates a first inference model by performing deep learning using this first training data (S1, S3). Inference is then performed for images using this first inference model, and images in the case where inference results in failure are made into test data candidate (S5 to S11). If the test data candidates reach a specified number, training data is recreated using this data, and a second inference model is generated using this training data that has been recreated (S13, S15). In this way since relearning is performed using training data that has been recreated, it is possible to perform inference of high reliability.

Also, the flowchart for the learning request system of this embodiment has a step of acquiring a learning model for true or false judgment that is generated based on a first request (refer to S1 and S3). Specifically, in this flowchart, the camera 100 or the learning request section 200 generates first training data (which is part of the information of the first request) in the learning section 300, and generates an inference model (learning model) based on this first training data. Also, the flowchart of the learning request system has a step of inputting specified test samples to a learning model and performing true or false judgment (refer to S5 and S7). Specifically, with this flowchart, a learning model (inference model) that has been input from the learning section 300 is used in true or false judgment (refer, for example, to NG judgment for within frame 2b in FIG. 2, OK and NG judgments of the inference engine 205 in FIG. 4, and to S5 and S7 in FIG. 6).

Also, the flowchart of the learning request system of this embodiment has a second request generation step for creating a second request in accordance with true or false judgment results (refer to S9, S11 and S13). Specifically, in this flowchart, second training data (which is part of the second request information) is created in accordance with results of true or false judgment, and relearning is requested to the learning section 300 (refer, for example, to within frame 2c in FIG. 2, image choosing, image processing and S9, S11 and S13 etc. in FIG. 4). This second request creates information other than test samples. Specifically, in this flowchart true or false judgment is performed using test samples, and the second request creates information other than test samples (for example, second training data).

It should be noted that the second inference model may be transmitted to the camera 100 by means of the learning request section 200, and may be transmitted directly from the learning section 300 to the camera 100. Also, a first inference model may be transmitted to the camera 100, and failure data of steps S5 to S9 accumulated in the camera 100, and the learning request section 200 may create second training data using this failure data.

Next, operation of the training data recreation in step S13 will be described using the flowchart shown in FIG. 7. This processing is executed by the control section 201 within the learning request section 200. It should be noted that as was described previously the control section 101 within the camera 100 may execute the processing for training data recreation shown in FIG. 7, using images that were acquired within the camera 100.

If the flow for training data recreation is commenced, first, first training data and test data candidates are acquired (S21). Here, the control section 201 acquires data for learning that was used when the learning section 300 generated the first inference model, that is, first training data, and test data candidates that were stored in step S9.

Next, contribution of similar images of test data candidates according to first training data is increased (S23). Here, as was described within frame 2b in FIG. 2, if inference has failed, images that are similar to images for which inference has failed have the level of contribution increased. For example, in a case where inference has failed due to an image being dark, as in the example shown within frame 2b in FIG. 2, light and shade of image P12 of the first training data may be adjusted to convert into a dark image. Specifically, similar images of test data candidates may be created by applying image processing in accordance with the cause of failure. Also, similar images to images for which inference has failed may be generated using GAN, which will be described later.

Next, contribution of images of low similarity of test data candidates of the first training data is reduced (S25). Here, the control section 201 reduces images that are not similar to candidates of test data for which inference failed. Specifically, these types of image have a high possibility of inference being successful, and even if these types of images are reduced the reliability of the second inference model data is generated in second learning will not become low. Contribution of images that are not similar to the test data candidates is therefore reduced. This processing corresponds to reducing contribution of images in the training data 402 of FIG. 4.

Next, negative samples are added and included in training data of similar images of the test data candidate (S27). Negative samples are images for which inference will fail. These types of images also cause improvement in reliability of the inference model, and so are added to training data. Next, similar images to test data candidate images in steps S23 to S27 are made into training data. Training data is not simply image data, and correct solutions are annotated to the image data. For example, in a case of inferring position of the eyes of a cat, information for designating position of the eyes of a cat is associated with image data. Information such as indicating correct solution of inference is associated with image data. This operation is called annotation. If similar images of test data candidates are made into training data, this flow is terminated and the originating flow is returned to.

Next, operation of individual devices of the learning request system will be described using FIG. 8A to FIG. 11. First, operation of the camera 100 will be described using the flowcharts shown in FIG. 8A to FIG. 8B. This operation is executed by the control section 101 within the camera 100 in accordance with a program that has been stored in memory.

If the flow for camera control shown in FIG. 8A is commenced, it is first determined whether or not the camera is in shooting mode (S31). It is possible to set various modes such as playback mode, shooting mode, inference model acquisition mode etc. in the camera 100. In this step, the setting control section 101b within the control section 101 determines whether or not shooting mode is set. It should be noted that in a second embodiment, specification setting is performed in steps S30 and S66a of the flow for camera control. In the first embodiment also, specification setting may also be performed in any of the steps of the flow for camera control of FIG. 8A and FIG. 8B. In this case, specific specification setting may be performed, such as shown in FIG. 21 and FIG. 22.

If the result of determination in step S31 is that the shooting mode has been set, images are input (S33). In this step a subject image is subjected to photoelectric conversion by the imaging section 103, and image data is acquired. This image data is used in generation of a live view image.

It is next determined whether or not to activate an inference engine (S35). Activation of the inference engine may be activation by, for example, the user manually operating the operation section 102. Also, in a case where specified conditions have been met, the inference engine may be automatically activated. For example, there may be cases such as (1) an image becoming a specified brightness or more, and (2) an image being analyzed, and the fact that the subject belongs to a category that an inference model that is set is particularly well-suited for has been identified, etc.

If the result of determination in step S35 is that the inference engine has been activated, inference is performed (S37). In this case, images that have been acquired by the imaging section 103 are input to the input section of the inference engine 104. The inference engine 104 performs specified inference on the input images. In this case the fact that inference is being performed may be displayed using text such as “operating”, as shown in images P21 to P26 in FIG. 3B.

If inference has been performed, it his next determined whether or not reliability is higher than a predetermined value (S39). The inference engine 104 can generally calculate reliability of the inference results for the inference currently being performed (previously described LOSS value). In this step therefore, it is determined whether or not reliability (LOSS value) of inference that was performed in step S37 is higher than a predetermined value.

If the result of determination in step S39 is that reliability is not high, it is determined whether or not it is scene should have been detected (S45). The fact that reliability is low may be because the inference was not expecting to detect this scene from the beginning. In the case of a scene for which an inference model that has been set is not particularly suited (a scene that is out of the area of expertise for that inference model), it is to be expected that reliability will be low. In this step the user may visually determine whether or not the scene is supposed to be detected, and if it is possible to perform determination by image analysis, the results of that analysis may also be used. If the user has performed determination visually, determination results may be input by manual operation of the operation section 102. Image P24 in FIG. 3B is an example where there has been a failure to detect a scene even though the scene is actually supposed to be detected.

If the result of determination in step S45 is that the inferred scene is supposed to be detected, this image is stored, and made a candidate for test data (S47). This case is a scene of low reliability in spite of the fact that it was a scene that should have been detected. In this type of case there are probably cases where it is better to perform relearning with that image as second training data. This image data is therefore stored as a test data candidate. For example, since with the image P24 shown in FIG. 3B it was not possible to detect position of the eyes of a cat by inference, that image P24 this made a test data candidate.

If an image has been stored as test data candidate in step S47, or if the result of determination in step S45 is that there was not a scene that should be detected, or if the result of determination in step S35 is that the inference engine is not activated, various parameters are controlled so that within the screen is photographed on average (S49). Here, general exposure control is performed, without performing inference on images.

Returning to step S39, if the result of this determination is that reliability is high, detection results are displayed (S41). Here, the inference result of step S37 is displayed on the display section 106 together with a live view image. For example, position of the eyes of a cat that has been obtained by inference are displayed with the balloon, as shown in images P22 and P25 in FIG. 3B.

Once detection results have been displayed, next various parameters are controlled based on the detection results so as to appropriately take photographs (S43). Here, the parameter control section 101e performs control of various parameters within the camera 100. For example, with the example shown in FIG. 3B position of the eyes of a cat are being detected using inference. If position of the eyes of a cat is detected focus adjustment of a focus lens is performed so as to focus on that position, and control values such as aperture and shutter are calculated so as to achieve correct exposure.

If parameters have been controlled in step S43 or S49, it is next determined whether or not there is movie shooting or still picture shooting (S51). The user observes the display section 106, and when composition and shooting opportunity etc. reach a condition that the user wants, they operate the release button or movie button etc. of the operation section 102. In this step, it is determined whether or not an operation to instruct shooting has been performed. If the result of this determination is that a shooting instruction has not been performed, processing returns to step S31.

On the other hand if the result of determination in step S51 is that a shooting instruction has been performed, shooting is performed and image data installed (S53). In this step, exposure control is performed in accordance with parameters that were set in steps S43 or S49. If exposure control is complete and the shutter is closed, image data that has been acquired by the imaging section 103 is subjected to image processing for still picture or for movie by the image processing section 101d, and this image data that has been subjected to image processing is stored in the storage section 105.

Once image data has been stored, it is next determined whether or not there has been an undetected object in a scene that should have been detected (S55). Regardless of whether there is a scene that should be detected during display of a live view image, if reliability of an inference result is low, that image is stored as a test data candidate (refer to S47). In this step, it is determined whether or not there was not detection using inference, even if there is a scene that should be detected at the time of shooting in step S53. If the result of this determination is No, processing returns to step S31.

If the result of determination in step S55 is that there was not detection using inference even if it was a scene in which something should have been detected, the image data is made a test data candidate (S57). Here, similarly to step S47, image data that was photographed in step S53 is stored as test data. Once this processing has been performed, processing returns to step S31.

Returning to step S31, if the result of determination in this step is not shooting mode it is determined whether or not an inference model etc. is to be acquired (S61). As a result of this operation of the operation section 102 of the camera 100, it is possible to set a mode for acquiring an inference model that will be set in the inference engine 104.

If the result of determination in step S61 is not that an inference model will be acquired, playback mode etc. is executed (S71). If playback mode is set, image data 105a that is stored in the storage section 105 is read out and displayed on the display section 106. For operational modes other than playback mode also, if there are appropriate modes that can be set, these can be accordingly executed. Once playback mode has been executed processing returns to step S31.

On the other hand, if the result of determination in step S61 is to acquire an inference model etc., next it is determined whether or not to request using own device (S63). An inference model is generated in the learning section 300, as was described previously. In this step it is determined whether to directly request from the camera 100 (own device) to the learning section 300, or whether to request mediation to the learning request section 200. Using the operation section 102, the user can set to request using own device, or to request mediation to the learning request section 200.

If the result of determination in step S63 is not to request using own device, mediation is requested (S73). In this case, the camera 100 requests mediation for generation of an inference model to the learning request section 200, by means of the communication section 107 and the communication section B203. At this time, the test data candidate that was stored in steps S47 and S57 is also transmitted. If mediation has been requested, the learning request section 200 performs processing similar to the flow that was shown in FIG. 7 to create second training data (refer to S101 and after in FIG. 10). Once mediation has been requested step S31 is returned to.

If the result of determination in step S63 is to request using own device, the number of test data is determined (S65). As was described previously, test data candidates are stored in steps S47 and S57. In this step, test data candidates that are stored are counted

Next, it is determined whether or not there is a need for relearning and whether relearning will be requested (S67). In the event that the number of test data candidates is greater than a specified number, the inference model that is currently being used becomes no longer suitable due to change in shooting environment, change in photographing materials etc. Also, there are cases where the user wishes to acquire a completely different inference model to the inference model that is currently set. In this step it is determined whether or not relearning is required based on these conditions.

If the result of determination in step S67 is that relearning is required, and acquisition of an inference model using relearning is requested, training data is recreated and relearning is requested (S69). Here, second training data is created taking into consideration the test data candidates, similarly to the flowchart that was shown in FIG. 7. Once second training data has been created, the second training data is transmitted to the learning section 300 by means of the communication section 107, and relearning is requested. Also, at this time, correction of annotation information may be performed on images. Requirement specification at the time of inference model generation may also be transmitted.

On the other hand, if relearning is not required and is not requested in step S67, it is next determined whether or not there is acquisition (S75). In this step it is determined whether or not a new inference model will be acquired. If the result of this determination is not acquisition, processing returns to step S31.

If the result of determination in step S75 is to acquire a new inference model, acquisition of the new reference model is performed (S77). In this case the specification setting section 101ba of the camera 100 transmits a requirement specification for the new inference model to the learning section 300, and the new inference model is generated in the learning section 300. If the learning section 300 has generated a new inference model, this new inference model is set in the inference engine 104 by being transmitted to the camera 100. If the new inference model has been acquired, processing returns to step S31.

In this way, in the flow for camera control, inference is performed on images that have been acquired by the imaging section 103, using the inference engine 104 (S37). In a case where reliability of this inference result is low, the inference engine 104 determines whether or not there is a scene that should be detected, and if there is a scene that should be detected image data at this time is stored as test data candidates (refer to S39 No, S45 Yes, and S47). When shooting has been performed also, if detection was not possible using inference, even if there was a scene that should be detected, image data this time is stored as test data candidates (S55 Yes, S57). In a case where relearning is required, the image data that has been stored as test data candidates is used when recreating training data (refer to S67 Yes, S69). This means that in cases where an inference model is no longer optimal, due to changes in photographed object and shooting material, it becomes possible to generate an inference model of high reliability.

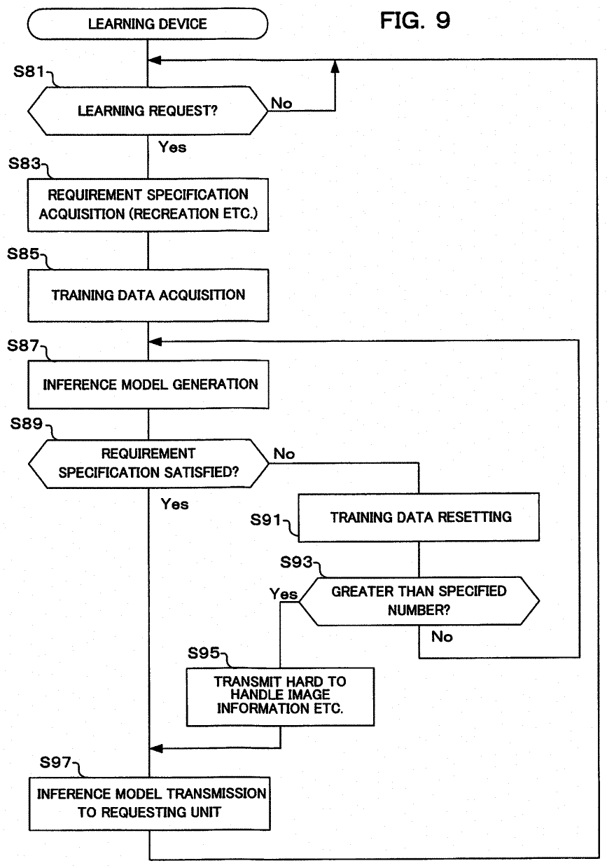

Next, operation of the learning section 300 will be described using the flowchart shown in FIG. 9. This flow is implemented by the control section 301 within the learning section 300 based on programs have been stored in memory.

If the flow for the learning device shown in FIG. 9 is commenced, it is first determined whether or not a learning request has been received (S81). In this step, the control section 301 determines whether or not generation of an inference model using deep learning has been requested, via the communication section, from the camera 100 or the learning request section 200 (refer to S73, S69, S77 etc. in FIG. 8B). If a learning request is not received, a standby state is entered in this step.

If the result of determination in step S81 is that a learning request is received, next a requirement specification is acquired (S83). At the time of receiving a request for generation of an inference model using deep learning, a requirement specification of the inference model is transmitted from the specification setting section 101ba, 204, of the transmission source. In this step, a requirement specification from the transmission source is received and stored.

Next, training data is acquired (S85). There may be cases where the camera 100 or the learning request section 200 that are the source of the learning request transmit training data (there may also be reference training data). In this case, the population creation section 302 creates a population (training data) for deep learning based on the training data that has been received. In the event that there is no reference training data, the population creation section 302 creates a population (training data) based on a requirement specification.

If training data has been created, next an inference model is generated (S87). Here, the input output modeling section 304 generates an inference model using training data that was acquired in step S85.

If the inference model has been generated, it is next determined whether or not the inference model satisfies the requirement specification (S89). Here, it is determined whether or not the inference model that was generated in step S87 satisfies the requirement specification that was acquired in step S83.

If the result of determination in step S89 is that the requirement specification is not satisfied, the training data is reset (S91). In the event that the inference model does not satisfy requirements of the requester, there is a possibility that the population (training data) that was created in step S85 is not suitable. The population creation section 302 therefore resets the population (training data) based on the requirements specification.

Once the training data has been reset, it is determined whether setting of the training data has been performed more than a specified number of times (S93). With this embodiment, an inference model is generated every time the training data is reset (S87), and it is determined whether the requirement specification is satisfied (S89). However, there may be cases where the requirement specification is not satisfied even if this processing is repeated a number of times. It is therefore determined in this step whether or not a number of times that the training data has been reset and an inference model generated is greater than a specified number of times. If the result of this determination is not greater than a specified number of times, processing advances to step S87 and generation of an inference model is repeated.

On the other hand if the result of determination in step S93 is that the number of times the training data has been reset is greater than the specified number of times, difficult to handle image information etc. is transmitted (S95). In a case where the requirement specification cannot be satisfied even if the training data has been reset a specified number of times, it can be said that it is difficult to generate an inference model that satisfies the requirement specification with images that have been used to generate an inference model. The fact that images relating to the requirement specification are difficult to handle is therefore transmitted to the requester.

If the result of determination in step S89 is that the requirement specification has been satisfied, or if difficult to handle image information etc. has been transmitted in step S95, an inference model is transmitted to the requesting unit (S97). Here, the inference model that was generated in step S87 is transmitted to the source of the request. In the event that the requirement specification was not satisfied in step S89, difficult to handle image information (refer to S95) and an inference model (refer to S97) are transmitted after specified processing. In this case, the requester can use the inference model for images other than images that are difficult to handle. Also, in a case where difficult to handle image information is transmitted, review of the training data may be obtained by avoiding performing transmission of the inference model. If an inference model has been transmitted, processing returns to step S81.

In this way, in a case where there is a learning request, the learning device 300 generates an inference model in accordance with a requirement specification (S83, S87), and once an inference model has been generated it is transmitted to the requester (S97). Also, in a case where reference training data has been transmitted from the requester, an inference model is generated by creating a population (training data) that includes this reference training data, and is comprised of data that is similar to the reference training data. In a case where second training data has been transmitted from the camera 100 or the learning request section 200 also, an inference model can obviously be generated in the same was as for with first training data.

Next, operation of the learning request device will be described using the flowchart shown in FIG. 10. This flow is implemented by the control section 201 within the learning request section 200 based on programs have been stored in memory. It should be noted that this flow is not limited to being executed in the learning request device, and may also be executed by devices other than the learning section 300 and the camera 100, for example, by an external unit such as a PC or smart phone.

If the flow for the learning request device shown in FIG. 10 is commenced, it is first determined whether or not there is a mediation request (S101). Here, it is determined whether or not the camera 100 has requested generation of an inference model via the learning request section 200, and not directly to the learning section 300. As was described previously, in step S73 (refer to FIG. 8B) the user of the camera 100 requests acquisition of an inference model to the learning request section 200. In this step determination is based on whether or not this request exists. If the result of this determination is that there is no request, the flow for the learning request device enters a standby state.

If the result of determination in step S101 is that there is a mediation request, test data candidates are acquired (S103). When requesting intermediation for inference model acquisition from the camera 100 to the learning request section 200, since the test data candidates that have been stored in the camera 100 (refer to steps S47 and S57) are transmitted, these test data candidates are acquired. Next the number of test data candidate is determined (S105). In this step, the test data candidates that were received in step S103 are counted. It should be noted that in the second embodiment, specification confirmation is performed in step S104 of the flow for the learning request device. In the first embodiment also, specification confirmation may also be performed in any of the steps of the flow for the learning request device of FIG. 10. In this case, specific specification setting may be performed, such as shown in FIG. 21 and FIG. 22.

Next, it is determined whether or not relearning is necessary and requested (S107). As was described previously, in the event that the test data candidates are greater than a specified number, the inference model that is currently being used becomes no longer suitable due to change in shooting environment, change in photographing materials etc. Also, there are cases where the user wishes to acquire a completely different inference model to the inference model that is currently set. In this step it is determined whether or not relearning is required based on these conditions.

If the result of determination in step S107 is that relearning is required, and acquisition of an inference model using relearning is requested, training data is recreated and if recreation was possible generation of an inference model is requested (S109). Here, second training data is created taking into consideration the test data candidates, similarly to the flowchart that was shown in FIG. 7. If second training data is possible, relearning is requested to the learning section 300, by means of the communication section B203, in order to generate an inference model. Also, at this time correction of annotation information may be performed on images. Requirement specification at the time of inference model generation may also be transmitted.

On the other hand, if there is no need to perform relearning in step S107, it is next determined whether or not there is acquisition (S111). In this step it is determined whether or not a completely new inference model will be acquired. If the result of this determination is not acquisition, processing returns to step S101.

If the result of determination in step S111 is to acquire a completely new inference model, acquisition of the new reference model is performed (S113). In this case the specification setting section 204 transmits a requirement specification for the new inference model to the learning section 300, and the new inference model is generated in the learning section 300. If the learning section 300 has generated a new inference model, this new inference model is set in the learning request section 200 by being transmitted to the camera 100. If a new inference model has been transmitted, processing returns to step S101.

In this way, in a case where the learning request section 200 has requested mediation for acquisition of an inference model from the camera 100 (S101 Yes), test data candidates are acquired from the requester, and whether or not relearning is required is determined based on the number of the test data (S105, S107). In the event that relearning is required, training data (second training data) is created based on test data candidates, and this training data is transmitted to the learning section 300 (S109). The learning section 300 generates an inference model by deep learning based on this training data (refer to S85 and S87 in FIG. 9).

Next, a method of generating image data that is similar to training data using a GAN (Generative Adversarial Network), will be described using FIG. 11. FIG. 11 shows a configuration for generating images that are similar to training data (test data) using a GAN. This GAN comprises two sections, which are generation AI (Artificial Intelligence) 500 and identification A1 510.

The generation AI 500 has an input section 304ba, a network design 304da, and an output section 304ca, and these sections function as a generator. This network design 304da, similarly to the previously described network design 304d, has intermediate layers (neurons) arranged between an input layer and an output layer. As intermediate layers a number of layers of neurons are arranged, and weights are assigned between respective intermediate layers using deep learning. If a noise signal P31 is input to the input section 304ba, the network design 304da performs inference using an inference model that is set, and outputs image P32 from the output section 304c. Input to the generator may be noise, and does not need to be a two-dimensional image. At an initial stage of inference model generation, the image P32 appears to be a defective image.

The identification A1 510 has an input section 304bb, a network design 304db, and an output section 304cb, and these sections function as a sorter. This network design 304db is also similar to the previously described network designs 304d and 304da, and so detailed description is omitted. An output image P32 from the network design 304da, or test data P33, is input to the input section 304bb. Also, data for learning P35 and P36 are respectively a false image and a true image, and are images for which solution has been known.

Image P32 or test data P33 is input to the input section 304bb, and whether an output result from the output section 304cb is “false” or “real” is determined based on LOSS value. If the result of this determination is that there are a lot of “false”, a LOSS value improvement request signal is transmitted to the generator side, and relearning is performed in the network design 304da. On the other hand, if the result of determination based on LOSS value is that there are a lot of “real”, test data P33 is input to the sorter side network design 304db, and relearning is performed by the sorter.

In this way, relearning using the sorter and relearning using the generator are made to compete in accordance with output result (LOSS value) from the network design 304db. By achieving an overall balance between learning, it becomes possible for the inference models of the network design 304da to successively generate images that are similar to images of test data (first training data) by inference. The network design 304dc sets an inference model that has been completed in the network design 304da. In this state, if a noise signal P37 is input to the network design 304dc, a large number of images P38 that are similar to the test data P33 (first training data) can be created by inference.

As was described previously, with the first embodiment of the present invention, the learning request device has an inference section that performs inference on second images that are different to a first image group, using a first inference model that was learned with first training data constituted of the first image group and annotation results for that first image group (refer, for example, to the inference engine 104, 205 of FIG. 1, the inference engine 205 of FIG. 2, the inference engine 205 of FIG. 4, and steps S1 to S5 in FIG. 6). Also, the learning request device has a correction section that determines inference results of the inference section, and outputs correction information for correcting the first training data (refer, for example, to the image acquisition selection, image processing, and correction of FIG. 4, and to S9, S11 and S13 in FIG. 6). As a result, it is possible to perform a request for relearning so that it is possible to perform inference of high reliability. Specifically, the first training data is corrected using inference results for a case where inference was performed by the first inference model that was generated with first training data, and is possible to request relearning using this first training data that has been corrected. It should be noted that the learning request device is not limited to the learning request section 200, and it is also possible for the camera 100 to fulfill that function.

Also, with the first embodiment of the present invention, the learning request device has a training data creating section that creates second training data based on error detection data at the time of having performed inference using the first inference model that was generated based on the first training data (refer, for example, to frame 2c in FIG. 2, the second training data 402 in FIG. 4, and to S13 in FIG. 6). Also, the learning request device has a communication section that requests relearning for generation of a second inference model based on second training data to the learning device (refer, for example, to the communication section B203 in FIG. 1A, the communication section 107 in FIG. 1B, S69 in FIG. 8B, and S109 in FIG. 10). As a result, it is possible to perform a request for relearning such that it is possible to perform inference of high reliability. Specifically, in a case where results of having performed inference based on the first training data are error detection, second training data is created based on this data, and it is possible to request relearning to the learning device by means of the communication section. It should be noted that the learning request device is not limited to the learning request section 200, and it is also possible for the camera 100 to fulfill that function.

With the device described in patent publication 1 above, although level adjustment of results that have been learned is performed, relearning based on results of level adjustment was not performed. Specifically, there is no consideration given to performing relearning to generate a more appropriate inference model. This means that there is a possibility of performing inference with reliability remaining low. With the learning request device of the first embodiment however, a request for relearning is performed in order to achieve inference of high reliability.

It should be noted that for the first embodiment of the present invention description has been given for a system that comprises a combination of a camera 100, learning request section 200 and learning section 300. However, the present invention is not limited to this combination and the camera 100 may also have the functions of the learning request section 200, and the learning request section 200 may have the functions of the learning section 300. Also, the test data may also be data that has been independently generated by the learning request section 200, without regard to test data from the camera 100.

Also, with the preferred embodiment of the present invention, learning in the learning device has been performing for deep learning, but this is not limiting, and may also be any learning that uses artificial intelligence, such as machine learning. Also, in recent years, it has become common to use artificial intelligence, such as being able to determine various evaluation criteria in one go, and it goes without saying that there may be improvements such as unifying each branch etc. of the flowcharts shown in this specification, and this is within the scope of the present invention.

Next, before describing a second embodiment of the present invention, information possessed by an image will be considered. Since images have an abundant information amount, in various fields images are used to confirm conditions of a photographed object. A family photograph or a landscape photograph are often used as support for memory with state of a physical object left in a photo print. These photographs may also tell the intention of the person taking the pictures and manner of physical objects etc. from viewpoints such as “art” and “esthetics” so as to appeal to an observer. However, on the other hand images are also widely used in order to objectively show conditions of an accident and assurance of operations. Images, as such “evidentiality”, have been required to be stored together with information such as what it is, and under what conditions was the image taken. Therefore, in many industries, schemes are implemented whereby at the time of performing image storage image information and other information relating to an image is associated in the system, and it is possible to confirm a plurality of items of information at the same time.

With advancements in computer technology and advancements communication technology, it is also possible to acquire other information at the same time as acquiring specified information. With a digital camera also, information on time and data and position is obtained at the same time as shooting, and many devices have specifications to store these items of information in association with image data. Also, this type of data is easy to search for using metadata, and many companies have as their business implementing schemes to make it easier to manage and use a plurality of items of information in cyberspace.

Further, images are generally imprint information arranged two-dimensionally, and also has a characteristic that easily appeals to the visual senses of a person who recognizes this information. Using this characteristic, there is usage known as thumbnails in images, and it is possible to display images that have been reduced side by side on a display, and usage such as the user choosing from within those images becomes possible. This utilizes a characteristic known as “legibility” of an image.

Accordingly, if an image file is made by associating various information with data of an image, it is possible to have a method of use such as verifying other information that has been associated while looking at an image. Information amount of images is significant, and the idea of setting, in large data such as that of an image, other data that is comparatively small, is perfectly natural. Selecting an image that has been listed, like thumbnails, from on a display, and reading out information associated with that image is also familiar, such as tile display of a smartphone, and is widespread as an intuitive selection method.

It is expected that in the future various problem solving will be performed using artificial intelligence. By providing technology whereby training data to be learned by artificial intelligence is provided in the form of image files, learning in accordance with users and conditions becomes possible in various scenes. Further, it can be expected that artificial intelligence solutions corresponding to more detailed scenes will be obtained. As has already been described, images have an extremely large amount of information, and what a physical object is, and how it is recorded, are very specific. This means that instructions for learning using images are extremely clear and logical. There are lines of thought that learning that is based on human abilities and sensibility can be easily performed, such as was already described with the example of thumbnails, and also that it is easy for these learning results to be helpful to humans. That is, utilization of image is effective as information that can be easily conveyed to a person, and that a person can intuitively and logically understand.

In the following, a learning request system comprising a camera, a learning section, and a learning request section will be described as a second embodiment of the present invention. The learning request system of the second embodiment has structures and operations that are common to the learning request system of the learning request system of the first embodiment, and the common structures and operations will be described with reference to the drawings relating to the first embodiment.

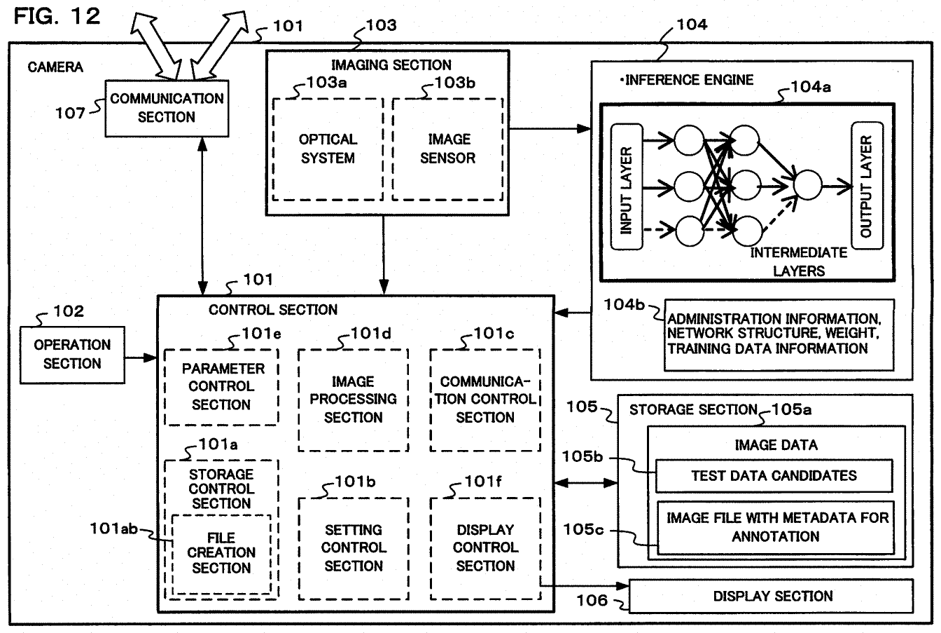

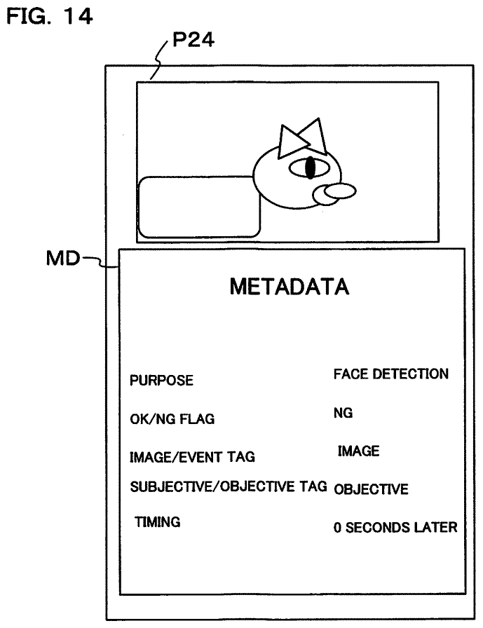

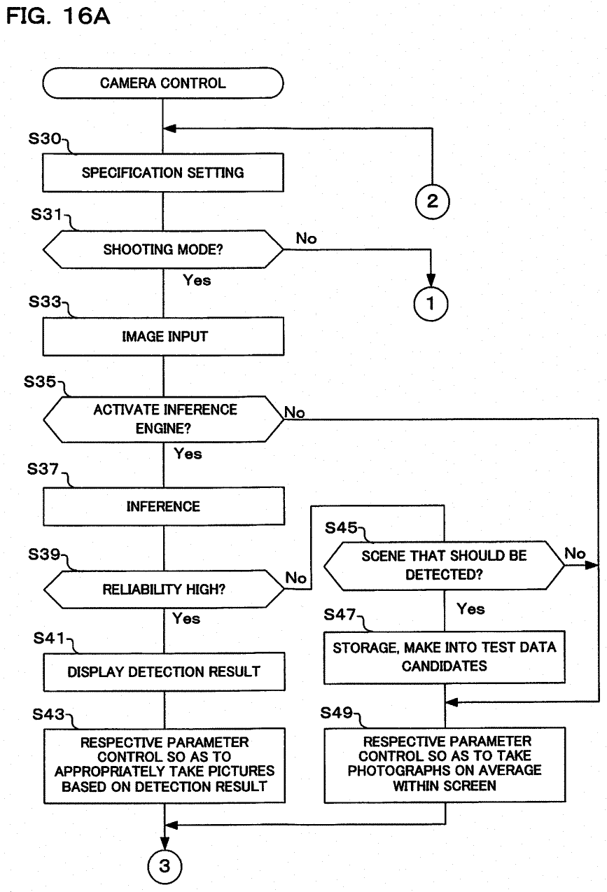

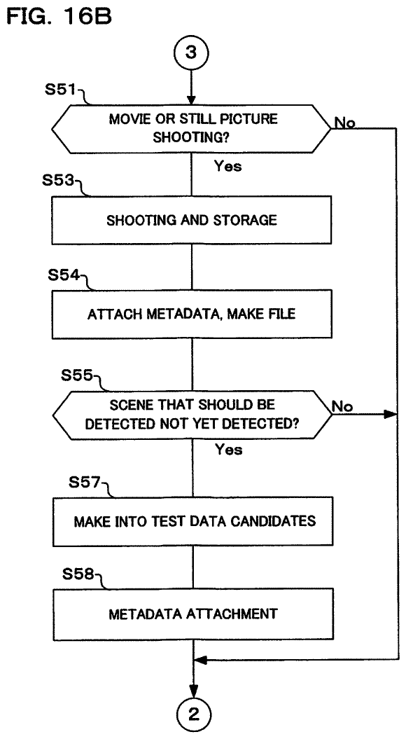

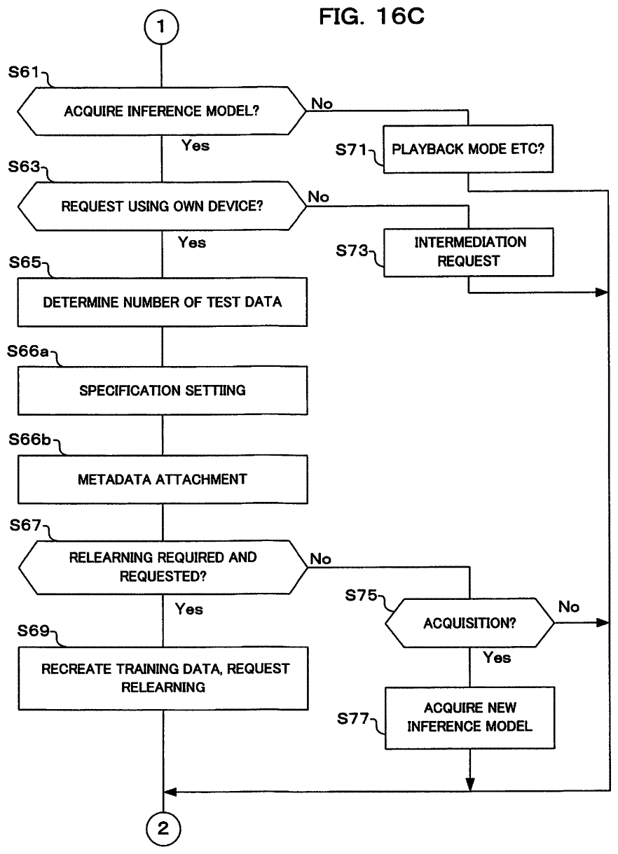

A camera of the learning request system of the second embodiment can generate an image file that has image data and metadata (refer, for example, to the file creation section 101ab in FIG. 12, and to FIG. 14 etc.). The following is an overview of the second embodiment. The camera comprises an imaging section 103 that outputs image data, and a file creation section 101ab, with the file creation section 101ab creating metadata for image data, and generating an image file in which this metadata is associated with image data (refer, for example, to FIGS. 14, S54 and S58 in FIG. 16B, and S66b in FIG. 16C). Image data with this metadata is transmitted by means of the communication section 107 to the learning section 300, in order to request learning in the external learning section 300.

Also, the learning section generates various inference models, for photographing support etc., using first training data (refer, for example, to S1 and S3 in FIG. 6). The camera can acquire image data using an imaging section. This camera has an inference engine, with inference for photographing support etc. being performed by the inference engine, and inference results displayed (refer, for example, to FIG. 12 and to S5 in FIG. 6). In the event that there is error detection at the time of display of this inference result, an image at this time (for example, image P24 in FIG. 3B) is stored as a test data candidate (refer, for example, to S9 in FIG. 6). The camera or the learning request section create second training data that will be used at the time of causing relearning in the learning section using test data candidates (refer, for example, FIG. 14, the second training data 402 in FIG. 4, and S13 in FIG. 6).

FIG. 1A and FIG. 12 are block diagrams showing an overall learning request system of this embodiment. This learning request system comprises a camera 100, learning request section 200 and learning section 300.

In summary, the camera 100 is a so-called digital camera, and, similarly to the first embodiment, has an imaging section 103, with a subject image being converted to image data by this imaging section 103, and the subject image being subjected to live view display on a display section 106 arranged on the rear surface of the camera body based on this converted image data. A photographer determines composition and photo opportunity by looking at the live view display. At the time of an instruction operation for actual shooting, image data is stored in the storage section 105. Image data that has been stored in the storage section 105 can be subjected to playback display on the display section 106 if playback mode is selected.

Detailed structure of the camera 100 in FIG. 12 will now be described. Similarly to the first embodiment, the camera 100 comprises a control section 101, operation section 102, imaging section 103, inference engine 104, storage section 105, display section 106, and communication section 107.

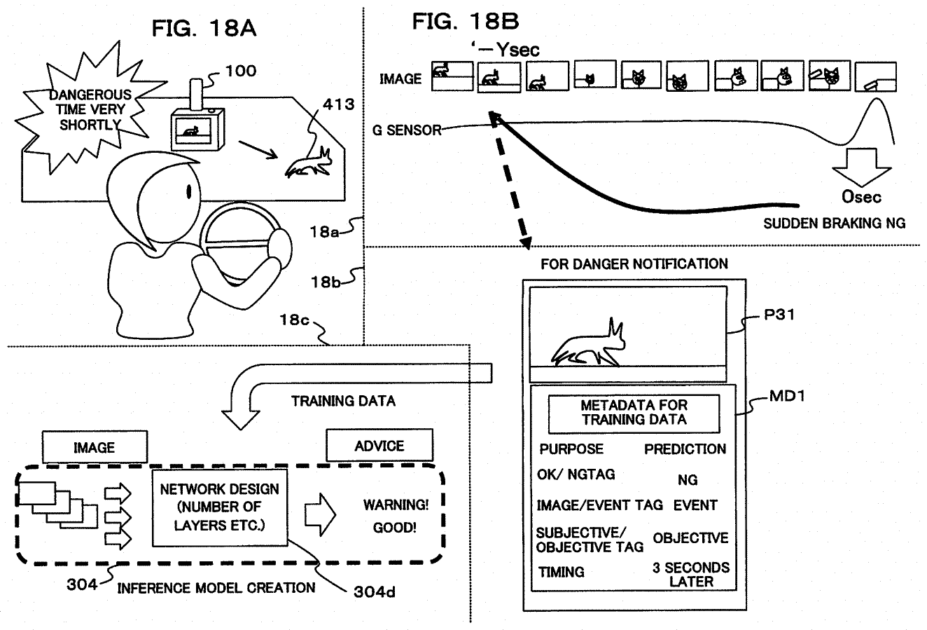

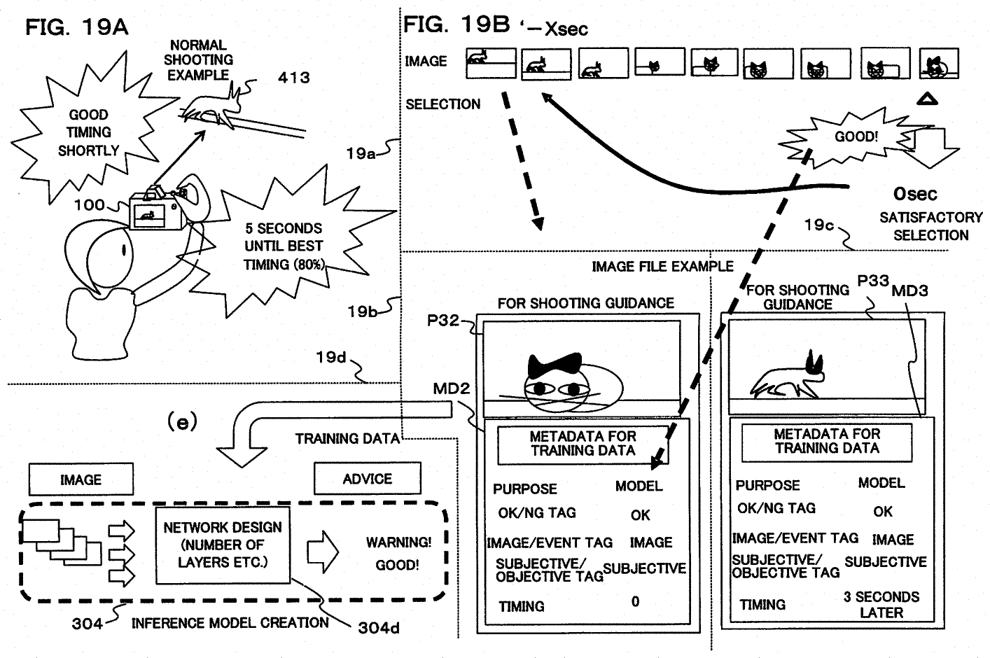

Since the operation section 102 and imaging section 103 are the same as in the first embodiment that was shown in FIG. 1B, the description in FIG. 1B will be incorporated, and detailed description will be omitted here. An image sensor of the imaging section 103 functions as an image sensor (imaging section) that converts a subject image to image data. The imaging section 103 functions as an image acquisition section that acquires images in accordance with continuous time (refer, for example, to FIG. 18B and FIG. 19B). Also, an operation section 102 functions as a user interface for designating purpose information. “purpose” shown in FIG. 14, FIG. 18B, and FIG. 19 is input by the user manually operating the operation section 102. In the event that the control section 101 can automatically determine purpose, the control section 101 fulfills the function of the user interface.

The inference engine 104 stores inference models, and performs inference for image data that has been input from the imaging section 103 using inference models that have been stored. An inference model that has been generated by the learning section 300, which will be described later, is input via the communication section 107, and stored. The inference engine 104 comprises network design 104a and administration information 104b. The inference engine 104 functions as an inference engine (inference section) that detects specific sections of an image by inference, using an inference model. The inference engine 104 functions as an inference engine (inference section) that is input with images and performs inference using an inference model (refer, for example, to S33 and S37 in FIG. 8A). The inference engine is not limited to being configured in hardware, and performing inference using software is also included.

Since the network design 104a and the administration information 104b are the same as in the first embodiment that was shown in FIG. 1B, the description in FIG. 1B will be incorporated and detailed description omitted here.

The storage section 105 is an electrically rewritable non-volatile memory. The storage section 105 has regions for storing image data 105a and test data candidates 105b, similarly to the first embodiment. This image data 105a and test data candidates 105b are the same as for the first embodiment that was shown in FIG. 1B, and so the description in FIG. 1B will be incorporated and detailed description omitted here.

Also, the storage section 105 has an image file 105c in part of the storage region for the image data 105a. This image file 105c is a region for storing an image file that may constitute training data. This image file is created by the storage control section 101a, which will be described later, and stores results of having produced image information in order to make training data at the time of machine learning. At the time of storing the image data 105a, an image file having image data and other auxiliary data associated with each other is stored, and it can be said that this image file is a file in which information on annotation relationships is associated with image data, as training data used at the time of machine learning.

Information on annotation relationships is information as described in the following, for example.

(a) For what purpose of training data is that image.
(b) Is it information in which inference and determination using that learning result is related to that image itself, or is it an image, event or information that is not related to that image itself but associated with that image.
(c) Is determination subjective, or objective.
(d) Is timing at which that determination was made before shooting, at the time of shooting, or a determination time such as after shooting.
(e) Associated image group information indicating whether there are other images that can be used in similar learning.
(f) Information such as is a previous determination an entire image, part of an image, or a physical object (position designation information within an image).
(g) Information such as will this image be made training data as is, or test data (hidden reference data).

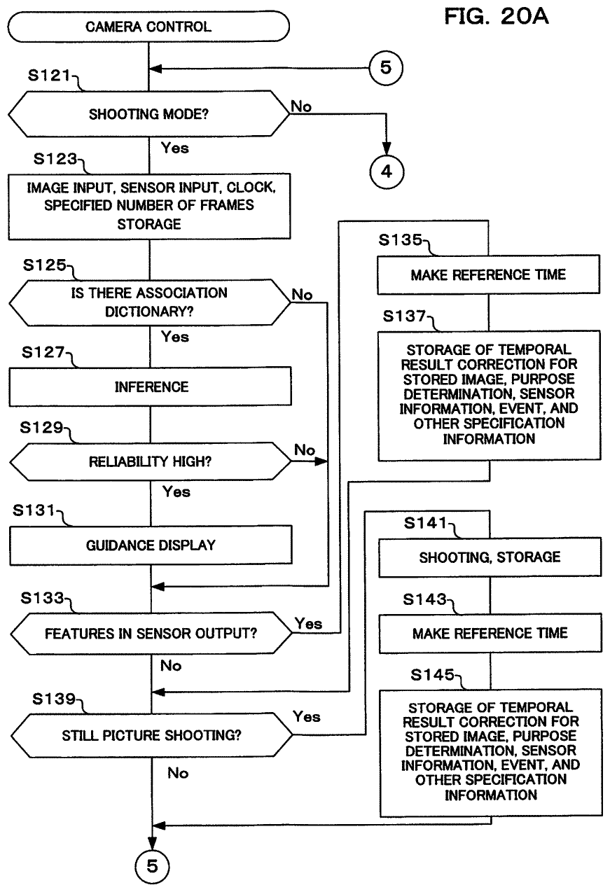

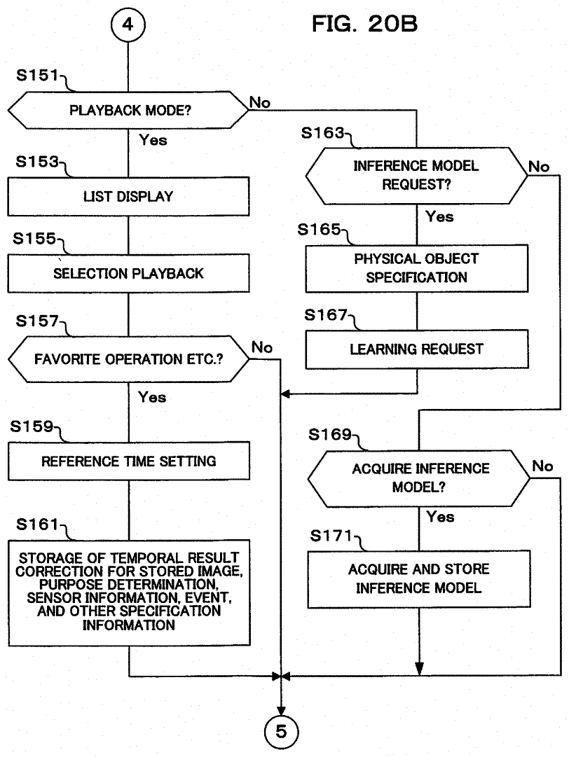

The display section 106 has a display such as an LCD monitor or an organic EL, and the communication section 107 has a communication circuit for performing transmission and reception. Since the display section 106 and the communication section 107 are the same as in the first embodiment that was shown in FIG. 1Bt, the description in FIG. 1B will be incorporated, and detailed description will be omitted here. The communication section 107 functions as a communication circuit (communication section) that transmits test data that has had metadata attached to the outside so as to be reflected at the time of relearning of an inference model (refer, for example, to S69 in FIG. 16C). A processor (control section 101) issues a request to the learning device so as to cause relearning of an inference model by reflecting test data in training data at the time of relearning (refer, for example, to S69 in FIG. 16C, and to FIG. 9). The communication section 107 functions as a communication circuit (communication section) for transmitting an image file that has been generated, having metadata attached by the metadata assignment section, to an external learning device (refer, for example, to S69 in FIG. 16C). The communication section 107 functions as a transmission section that transmits images with metadata to the learning device, as training images for particular event prediction (refer, for example, to S167 in FIG. 20B).

The control section 101 is a processor that is made up of an ASIC (application-specific integrated circuit) including a CPU (central processing unit) etc. and various peripheral circuits. The control section 101 comprises a storage control section 101a, a setting control section 101b, a communication control section 101c, an image processing section 101d, a parameter control section 101e, and a display control section 101f. Each of these sections is implemented using hardware circuits, and some parts are realized in accordance with a CPU and programs that have been stored in nonvolatile memory. The control section 101 controls the whole of the camera 100 in accordance with the CPU and programs.

There is also a clock section having a clock function within the control section 101. This clock section functions as a clock section that acquires continuous time information. Also, the control section 101 has a sensor information acquisition section that is input with information from various sensors (not illustrated), such as an acceleration sensor within the camera, and acquires information on these sensors. This sensor information acquisition section functions as a sensor information acquisition section that acquires sensor information of other than images, in accordance with continuous time (refer to S133, S137, and S145 in FIG. 20A).

The control section 101 functions as a determination section that determines images for which specific sections could not be detected with an inference model (refer to S7 in FIG. 6A, and S37 and S39 in FIG. 16A). The determination section determines that specific sections could not be detected in a case where specific sections could not be detected for images that were acquired before and after images for which specific sections could be detected (refer, for example, to images P22 to P25 in FIG. 3B).

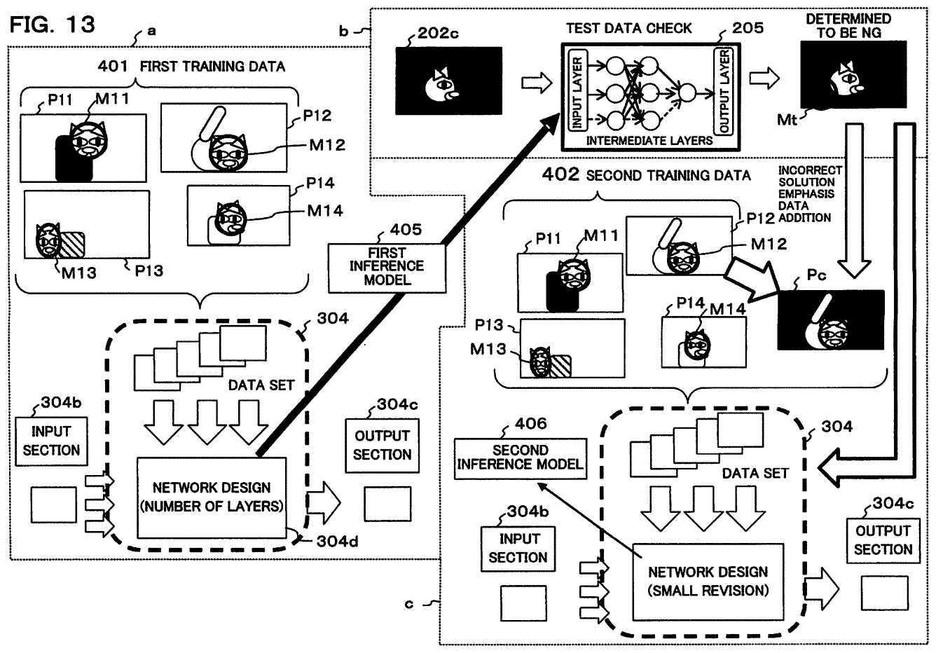

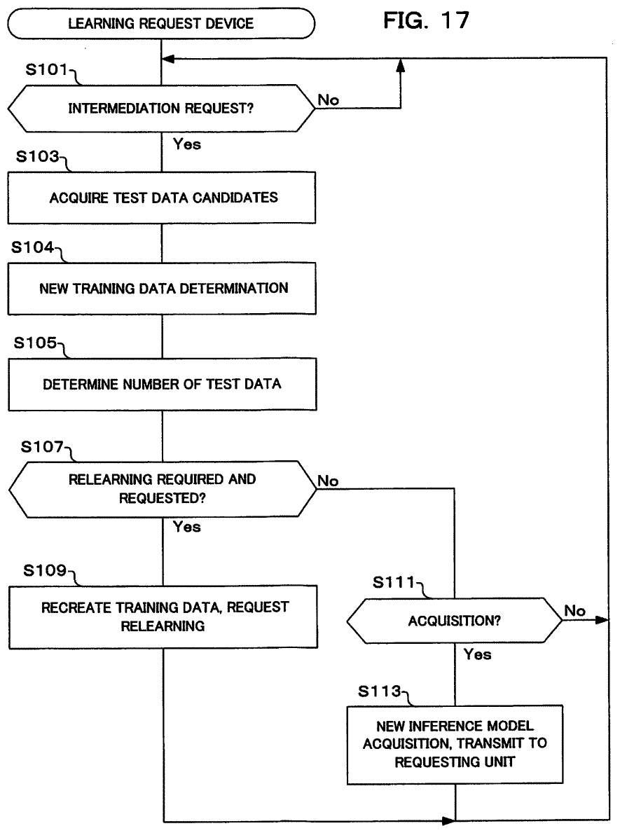

The control section 101 functions as a correction section that determines inference results of the inference section, and outputs correction information for correcting first training data (refer, for example, to generation of image Pc in FIG. 13, the correction in FIG. 4, and S13 in FIG. 6). The correction section increases or decreases image data that is contained in the first training data in accordance with the inference results, or performs image processing on the image data (refer, for example, to frame 2b in FIG. 2, and to FIG. 4). Also, the control section 101 performs inference using a first inference model for image data that has been acquired by the imaging section, and makes the image data candidates for test data if inference results are error detection (refer, for example, to image P24 in FIG. 3B, and S9 in FIG. 6). Also, the control section 101 functions as a request section that creates second training data based on correction information, and requests relearning to generate an inference model based on this second training data (refer, for example, to S13 in FIG. 6, S69 in FIG. 16C, and S109 in FIG. 17).

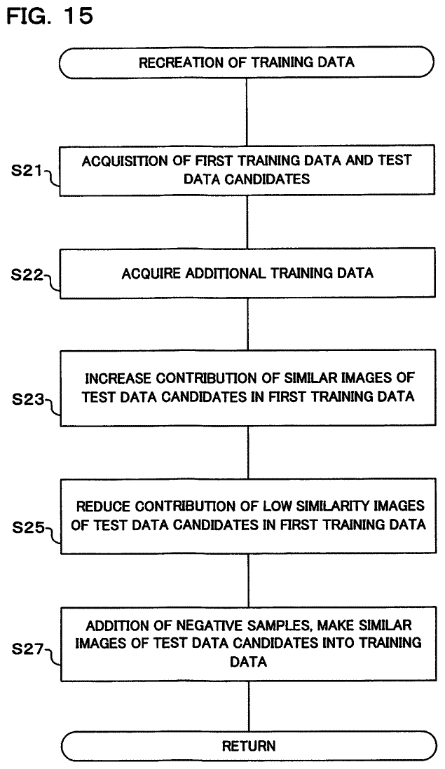

The control section 101 functions as a training data creating section that creates second training data based on error detection data at the time inference was performed using a first inference model that was generated based on first training data (refer, for example, to S7 and S9 in FIG. 6). The training data creating section increases or decreases image data that is included in first training data based on images at the time of error detection, or applies image processing to image data (refer, for example, to FIG. 13, FIG. 4 and FIG. 15). The control section 101 functions as a re-learning request section that requests relearning by transmitting correction information from a transmission section to the learning device (refer, for example, to S15 in FIG. 6 and S69 in FIG. 16C). Also, the control section 101 functions as a re-learning request section that requests relearning by determining inference results of the inference section, and transmitting third images that are different to the first images and second image from the transmission section to the learning device, to acquire a second inference model that is different to the first inference model. For example, in FIG. 13, the first images correspond to the first training data 401, the second images correspond to the test data (202c), and the third images correspond to emphasis data Pc.

The storage control section 101a controls storage of image data etc. that is stored in the storage section 105. Specifically, storage of image data that has been acquired by the imaging section 103 and subjected to processing by the image processing section 101d is controlled. Also, in a case where results of inference by the inference engine 104 are not appropriate, test data candidates are stored in the storage section 105. The storage control section 101a functions as a storage control section that stores images for which specific sections could not be detected by the determination section, as test data.

The storage control section 101a has a file creation section 101ab. This file creation section 101ab creates an image file in which image data and other auxiliary data are associated with each other, at the time of image storage. This image file is created by defining and arranging data of image associated information, as information of training data for machine learning, in accordance with specified rules. An image file that has been created by this file creation section 101ab is stored as an image file 105c having metadata for annotation, in a region within the storage section 105. Annotation-related Information is information of (a) to (g) described previously.

This annotation information may be set by the user performing manual operation, may be set by voice input, and may be set by determination using a database for every specified condition. Whether to make this annotation information training data or set in test data may be designated. Specifically, it may be possible to perform division that has considered individual information and portrait rights etc. That is, if images that have a problem with regard to individual information are made training data at the time of machine learning by another device, a problem arise with regard to security.

Therefore, in an image file generating device that generates an image file having image data and metadata, when creating an inference model to which images having metadata that is associated with image data are input, a metadata assignment section may be provided to assign

1. purpose information that designates output of the inference model, and
2. information as to whether to make the image data training data for learning or make it hidden reference data, as metadata. With this image file generating device it becomes possible to perform management for hidden image data. That is, in the case of hidden reference data, if information indicating that fact is attached to metadata, a learning request with this information made a reference becomes possible.

In other words, the file creation section 101ab of the storage control section 101a functions as a metadata assignment section that attaches at least one of the following information,

(a) purpose
(b) is subject of determination an image or a phenomenon
(c) is determination subjective or objective
(d) determination timing (is it before shooting, at the time of shooting, or after shooting)
(e) associated image group information
(f) is determination for an entire image, for part of an image or for a physical object
(g) make into training data or make into test data (hidden reference data) as metadata,
in order to create an inference model that is input with image data, and outputs information relating to purpose that has been designated in metadata of the image file. This metadata is used as annotation information at the time of creating an inference model. Specifically, it is possible to provide an image file generating device that comprises a metadata assignment section that attaches annotation information as metadata.

The file creation section 101ab functions as a metadata assignment section that attaches (1) purpose information for designating purpose of the inference model and (2) information as to whether the image data will be made into training data for externally requested learning, or made into hidden reference data, as metadata when creating an inference model that is input with images associated with image data. Also, besides the above (1) and the above described (2), the metadata assignment section also attaches at least one of (3) information as to whether what is being determined is an image or a phenomenon, (4) information as to whether determination is subjective or objective, (5) information on determination timing, (6) associated image group information, and (7) information as to whether determination is for an entire image, part of an image or a physical object, as metadata. It should be noted that in a case where data of the purpose information in (1) described above that is attached in the metadata assignment section is predetermined to be exchanged between dedicated units, the metadata assignment section may not need to attach the purpose information of (1) described above. Also, the metadata assignment section may not need to attach the information of (2) described above in a case where data regarding whether image data is for externally requested learning or made into hidden reference information in (2) described above is predetermined to be interchanged between dedicated units.

The control section 101 functions as a processor that has a metadata assignment section. At the time of creating an inference model that has images associated with image data that has been made training data candidates, the metadata assignment section attaches at least one of (1) purpose information for designating purpose of inference of the inference model, (2) information as to whether what is being determined by the inference model to be created is an image or a phenomenon, (3) information as to whether the basis of what is determined by the inference model to be created is subjective or objective, (4) information relating to time of determination by the inference model that will be created, and (5) information as to whether determination by the inference model that will be created is for an entire image, part of an image or a specified physical object, as the metadata. Here, the expression “specified physical object” in (5) is an abstraction, and may be a physical object ‘that has been designated” by the user.

Also, the control section 101 functions as a processor that has a metadata generating section for generating metadata (refer, for example, to FIG. 18B and FIG. 19B). This metadata generating section generates metadata in order to designate (1) if inference is for detecting a physical object within an image, and (2) whether inference is for predicting change in images that are continuous in time. The metadata generating section generates metadata based on information corresponding to time before and after images have been acquired.

As information corresponding to time before and after images have been acquired, the metadata generating section, in a case where there are images that have been selected by the user, generates metadata for prediction inference for predicting change in images that are continuous in time, with time of that acquisition as information corresponding to the time (refer, for example, to FIG. 19B), or, if there is acquisition of specified sensor information, generates metadata with acquisition time of the sensor information as information corresponding to the time (refer, for example to FIG. 18B). The metadata generating section generates metadata with retroactive times as annotation information, in the event that specified purpose information is for prediction inference (refer, for example, to FIG. 18B, and S135, S137, S143 and S145 in FIG. 20A).

The metadata generating section generates metadata for inference in order to detect a physical object within an image in accordance with whether it was possible to detect part of an image corresponding to a specific physical object, within images that have been acquired at times before and after images have been acquired, as information corresponding to times before and after images were acquired (refer, for example, to FIG. 19B). The metadata generating section generates information as to whether image data will be made training data for externally requested learning, or made hidden reference data, as metadata.

The metadata generating section determines predicted value for the above described prediction purpose, by sensor synchronized determination that automatically determines specified conditions and/or manual release determination while confirming live view display by a user. Here, synchronized determination is determination for synchronizing prediction, based on output of sensors provided inside or outside the camera. Face detection that is performed based on image data can be said to be sensor synchronized determination. Also, release determination is performing determination using timing at which a user performs operation of an operating section, such as a release button. Storage sections within the storage section 105 or the control section 101 function as memory for storing sensor synchronized determination and/or release determination as information corresponding to times before and after an image has been acquired.

The metadata generating section makes information as to whether selection has been performed objectively or subjectively into metadata, as information corresponding to times before and after images have been acquired (refer to FIG. 14, FIG. 18B, and FIG. 19B). Here, “objective” means an act of determining objectively, like warning notifications such as shown in FIG. 18A and FIG. 18B, regardless of the user's intentions (subjective). Also, subjective means the user's subjectivity, for example, determination in accordance with user preferences, such as shown in FIG. 19.

The metadata generating section generates metadata with images that are not for prediction as candidates for detection usage for detecting a physical object contained in an image. In a case where it has been determined that inference is for detecting a physical object within an image, the metadata generating section generates information as to whether an inference model to be created is for quality of the physical image itself, or for images that change in association with an event. Here, quality of an image itself also includes information such as does it constitute a photograph the user is satisfied with, for example. Images that change in relation to an event also include images in which conditions change, in accordance with time lapses such as an event of a cat suddenly jumping out, as shown in FIG. 18B, for example.

The metadata generating section generates and attaches metadata for test data. The metadata generating section creates metadata in accordance with inference results from the inference section, and generates an image file by associating meta data that has been created with image data (refer, for example, to S5 to S13 in FIG. 6). The metadata generating section creates metadata in a case where inference results from the inference section have failed (refer, for example, to S7 in FIG. 6). The metadata generating section creates metadata at the time of image data acquisition, and generates an image file by associating this metadata with the image data (refer, for example, to FIG. 6C). The metadata assignment section assigns identification information representing an inference model that applies additional learning, when requesting additional learning by transmitting the image file that has been generated to an external learning device. The metadata assignment section attaches time information to images that have been acquired at a retroactive time as metadata, by referencing time at the point of the event in which sensor information changed (refer, for example, S137 and S145 in FIG. 14A). The metadata assignment section attaches information as to whether or not a specified event is an event that should be publicized, as metadata (refer, for example, to S137 and S145).

The setting control section 101b performs various settings of the camera 100. As various settings, settings such as of shooting mode, and setting of inference by the inference engine 104, is performed. Content of this inference that has been set is transmitted to the learning request section 200 or the learning section 300 as specifications. As specifications, at the time taking a picture of a cat, for example, the eyes of the cat are focused on, and if the user wants advice such as to make the picture cute, if they input a request using the operation section 102 the setting control section 101b performs setting so that it is possible to acquire an inference model that is suitable for the user to receive this advice.

The communication control section 101c performs control of communication by the communication section 107. The image processing section 101d has an image processing circuit, and performs various image processing on image data that has been acquired by the imaging section 103. The parameter control section 101e has a parameter control circuit, and controls various parameters for performing shooting. The display control section 101f has a display control circuit, and performs control of display on the display section 106. The communication control section 101c, image processing section 101d, parameter control section 101e, and display control section 101f are the same as in the first embodiment that was shown in FIG. 1B, and so the descriptions in FIG. 1B will be adopted and detailed description will be omitted here.

Next, the learning request section 200 of the second embodiment will be described. The learning request section 200 is, for example, a server that is capable of connecting to the learning section 300 and camera 100 by means of the Internet. The learning request section 200 is the same as the learning request section 200 shown in FIG. 1A, and comprises a control section 201, image classification and storage section 202, communication section B203 and specification setting section 204. This learning request section 200 has a database (image classification and storage section 202) for storing training data that has been created from image data that has been acquired by the camera 100, and requests inference, that uses reference training data 202b and test data 202c based on this image data that has been stored, to the learning section 300. Each of these sections is the same as in the first embodiment that was shown in FIG. 1A and so the descriptions in FIG. 1A will be adopted and detailed description omitted.

The learning request section 200 functions as a server that provides training data. The communication section B203 functions as a reception circuit that receives image data and metadata relating to the image data. It should be noted that as long as metadata is data such that it is possible to understand a relationship with image data, metadata need not be attached to image data. A processor within the control section 201 functions as a processor comprising a collecting section and provision section. A collecting section determines whether metadata indicating usage information that has been designated is (1) inference for detecting a physical object within an image, or is (2) inference for predicting change of images that are continuous in time series, and gathers image data by classifying in accordance with the result of determination (refer to S107 and S109 in FIG. 17). The provision section provides image data that has been collected by the collecting section as a training data group (refer to S109).

Next, the learning section 300 of the second embodiment will be described. The learning section 300 is the same as the learning section 300 shown in FIG. 1A, and is a server that is capable of connecting to the learning request section 200 and the camera 100 etc. by means of the Internet, and receives requests from outside, such the camera 100 and learning request section 200 etc. to generate an inference model. The learning section 300 comprises a control section 301, a population creation section 302, a reference training data storage section 303, an input output modeling section 304, a communication section A305a and a communication section B305b. This learning section 300 generates an inference model using training data, in accordance with specifications that have been requested from the camera 100 or the learning request section 200. This inference model that has been generated is transmitted to an external device (learning request section 200, camera 100) by means of the communication section A305a and communication section B305b. Each of these sections is the same as in the first embodiment that was shown in FIG. 1A and so the descriptions in FIG. 1A will be adopted, only characteristic sections will be described, and detailed description omitted. With this embodiment also, deep learning can be performed similarly to as in the first embodiment.

The reference training data storage section 303 has an electrically rewritable non-volatile memory, and stores reference training data 202b that has been transmitted from the learning request section 200. Also, in a case where training data has been created by the camera 100, this training data is stored (refer to S69 in FIG. 16C). As will be described later, in the event that generation of an inference model is being requested from the camera 100 or learning request section 200, when the population creation section 302 generates training data (data for learning), training data is created by including reference training data, or training data is created with reference to training data.

Generally, annotation is applied to an image that has been taken itself, and if this annotation is made training data there is a risk of information relating to portrait rights or individual information being inadvertently output. For this reason, a taken image may be temporarily made a test data candidate, appended with metadata that is in accordance with specification for annotation in accordance with a user's setting specification, and then made into test data that will be used internally. Also, relearning may be requested externally as training data (or a recreation request for training data). In a case where there is no fear of outflow such as individual information or portrait rights, training data may be transmitted, and not test data. At this time a request for correction or revision of information on annotation to external images that have already been prepared as training data may be issued, and a requirement specification for relearning may be transmitted.

Next, the data for learning (training data) used in the deep learning of this embodiment will be described using FIG. 13. In the second embodiment also, similarly to the first embodiment of FIG. 2, image data Pc resulting from having corrected images of first training data is generated, and inference is performed using second training data to which this image data Pc has been added. Specifically, in a case where inference has failed (NG) in b of FIG. 13 (NG has been determined), emphasis data is created by correcting images of the first training data, this image data Pc of a cat that has been corrected is transmitted to the learning device 300, and the learning device 300 performs inference using second training data to which image Pc has been added in addition to the first training data, to generate a second inference model 406. This second inference model is an inference model that has made a small revision to the network design 304d, and can infer position of eyes even if it is a dark image of a cat, for example. Relearning is requested to the learning section 300 so as to generate an inference model using this second training data (refer, for example, to S69 in FIG. 16C, and S109 in FIG. 10).

In this way, in the first embodiment second training data was generated by correcting image data of the first training data. With the second embodiment, in addition to the correction of image data of the first embodiment, metadata is added to the test data 202c. Specifically, an image is corrected, metadata is added to test data 202c without generating emphasis data Pc, and that test data may be made part of the second training data directly. Making training data by adding this metadata will be described later using FIG. 14.

Also, in the description of within frame 2b in FIG. 2, checking of the inference model was performed using test data in the learning request section 200, and second training data was created. However, checking of the inference model using test data may be similarly performed in the camera 100, and the second training data created. Also, other than correcting images of the first training data using normal image processing, images that are similar to the images of the first training data may also be created using a GAN (Generative Adversarial network), which was described using FIG. 11.

Next, an example of acquisition of test data candidates will be described. Acquisition of test data candidates may be performed using the method shown in previously described FIG. 3A and FIG. 3B. That is, the test data 202c has images that did not obtain expected inference results, when shooting was performed with the camera 100 having the inference engine 104 installed, set as test data candidates (refer, for example, to S5, S7 and S9 in FIG. 6). Since the acquisition of test data candidates in FIG. 3A and FIG. 3B is the same as for the first embodiment, the descriptions of FIG. 3A and FIG. 3B will be adopted and detailed description is omitted.

In FIG. 3B, images for which inference failed have been made test data candidates. However, test data candidates that were detected at the time of shooting may immediately have metadata attached (be made into annotation) to create test data or training data. Specifically, in a case where test data candidates have appeared, test data or training data may be immediately created. FIG. 14 shows an example where, in a scene set by a user, such as P24 in FIG. 3B, when an image it is wished to detect has been taken, metadata is immediately attached.

With the example shown in FIG. 14, an image file having metadata MD associated with image P24 is generated. What purpose, an OK/NG flag, image/act tag, subjective/objective tag, timing etc. are stored in this metadata MD. With the example shown in FIG. 14 purpose is “face detection”, and since this is an example in which face detection was not performed well the OK/NG flag is “NG”. Accordingly, since this image P24 does not satisfy the user, it constitutes an example of an image in which face detection is desired. Also, with the example of the metadata MD of FIG. 14, it is not for learning of some event, and learning is performed for this image itself and so “image” is set, the fact that it is under conditions in which there is a problem even from an “objective” aspect, not from a subjective aspect, such as face detection has failed, is indicated, and since there was a problem with timing right at the time of shooting, timing is set to “0 seconds”. Also, although not shown in the drawings, as metadata MD, information as to whether this image data is made training data for externally requested learning, or made hidden reference data, may be generated. It should be noted that as metadata MD, besides the above described example, dates and shooting parameters may also be added, and thumbnail images may also be added.

In this way, at a shooting location, if it is possible to immediately determine whether inference results of an inference model are good or bad, and the limitation with the inference model, it becomes possible to provide a device that can perform shooting in line with the user's intentions the more it is used, for example. With this type of scheme, it is possible to provide technology and services that can acquire inference models that are more suitable to actual scenes and exceed design levels. However, images for AI that are collected based on metadata at the time of creating a new inference model, or at the time of improving an inference model that has already been created, and used as training data or test data, can be said to be so-called self-reporting images. As a result, at a scene where learning is actually performed, similar images for AI can be selected with the possibility of being omitted.

Also, by having metadata such as described above, an assumption can be known regarding what type of inference model would be used to infer an image. Accordingly, a system such as designating an inference model from metadata is also conceivable. In this way, images having data of this format can be used effectively in an inference phase also, and not only in a learning phase. Images having this type of metadata may also be called images that are suitable for AI. Also, since images having this type of metadata are suitable for AI, it is further desirable to apply tamper proofing and prevention measures against malicious metadata creation, etc. if it is assumed that metadata will be attached to images including sufficient information to be suitable for being inferred for new information. This may be performed by means of a scheme such as introducing monitoring technology to correctly administer within a system for handling images may be implemented.

The previously described method for generating second training data from first training data shown in FIG. 4, can also be applied to the second embodiment. Therefore, since the method of generating second training data from first training data shown in FIG. 4 is the same as that of the first embodiment, the descriptions in FIG. 4 will be adopted, and except for characteristic points detailed description is omitted.

It should be noted that with the first embodiment correction images were generated by choosing images and performing image processing, and adding these correction images to second training data. However, in addition to this method in a case where annotation is performed on test data candidates at the time of shooting (attaching of metadata MD), as was described using FIG. 14, and test data was created, this test data may also be used.

However, there is no limitation to the learning request section 200, and the second training data may also be generated in the camera 100. The training images may also be increased using a GAN (Generative Adversarial network) (refer to FIG. 11). Also, in a case where annotation is performed on test data candidates at the time of shooting (attaching of metadata MD), as was described using FIG. 14, to create test data, if there is no issue with regard to confidentiality and copyright with the images, this test data may also be used as second training data.

In the second embodiment also, a relationship between training data and test data is the same as that of the first embodiment that was described using FIG. 5. The descriptions in FIG. 5 are therefore adopted, and except for characteristic points detailed description is omitted. It should be noted that test data means that the data is used in reliability testing of an inference model internally (refer to the test data check shown in frame 2b in FIG. 2, and the learning request section 200 in FIG. 4). However, if there is no problem with confidentiality in the test data, then by associating metadata MD with image data (annotation) as was described using FIG. 14, the test data may be made training data as is.

Next, overall operation of the learning request system of the second embodiment (refer to FIG. 1A and FIG. 12) will be described using the flowcharts shown in FIG. 6 and FIG. 15. This flow is implemented by controlling the system overall by cooperative operation of the control section 101, control section 201, and control section 301. However, this is not limiting, and implementation may also be performed with a single unit, may be performed with any two units, and may be performed in cooperation with yet another unit (a fourth unit). In many cases people and devices that will use first learning, second learning, and an inference engine will be different.

The flow for the learning request system shown in FIG. 6 executes substantially the same processing in the second embodiment also, and so description will mainly be for characteristics of the second embodiment. If the flow of the learning request system is commenced, then first, first training data is created based on a specification (S1). In this step, the population creation section 302 of the learning section 300 creates first training data. When creating this first training data, specifications of an inference model for which generation is requested to the learning request section 200 is transmitted from the specification setting section 204 of the learning request section 200. This specification may be designated by the maker who manufactured the imaging device, and the user may directly request specification using a device (unit). As a specification designation method, besides transmitting text data etc. there may also be a method of transmitting sample images from the requester. In this case content that has been described in metadata of a sample image file may be analyzed and determined. At the time of selecting first training data, metadata information of the image file may be used. Further, in a case where there is an intermediary, such as an intermediate customer, there may be a method of transmitting through the intermediary. In this type of condition also, there is the advantage that it becomes possible to deliver correct data depending on legibility of the image.

Also, in a case where reference training data 202b that is stored within the learning request section 200 is transmitted together with transmission of the specification for the inference model, the reference training data is stored in the reference training data storage section 303 within the learning section 300. The population creation section 302 creates a population (first training data) for an inference model based on the request (specification) from the learning request section 200. At this time, reference training data 202b may also be included, and first training data may also be created by gathering similar data with reference to the reference training data 202b. Since the first training data is used in deep learning, image data that is input to an input section, and correct solutions of inference results, are included. Specifically, correct solution information for inferences are associated with the first training data by performing annotation on images. This first training data corresponds to the first training data 401 shown in a in FIG. 13, and in FIG. 4. It should be noted that, as was described previously, test data candidate may be used directly in training data. In this case, the user may set that test data candidates are used in step S1.

Once the first training data has been created, next first learning is executed using the first training data (S3). Next, inference of the first learning results is performed by the inference engine, and reliability is measured (S5), and it is determined whether or not result of determination is failure (S7). If the result of determination in step S7 is failure, test data is made into a candidate (S9). Next, it is determined whether or not a number of items of test data candidate data has reached a specified number (S11).

If the result of determination in step S11 is that test data candidates have reached a specified number, next training data is recreated (S13). It should be noted that test data means that the data is used in reliability testing of an inference model internally (refer to the test data check shown within frame 2b in FIG. 2, and the learning request section 200 in FIG. 4). However, if there is no problem with confidentiality in the test data, then by associating metadata MD with image data (annotation) as was described using FIG. 14, the test data may be made training data as is. In this case steps S9 and S11 are skipped and processing advances to step S13.

If training data has been recreated, next, second learning is performed using second training data (S15). If the camera 100 or the learning request section 200 has recreated training data as second training data, this second training data is transmitted to the learning section 300. The input output modeling section 304 performs second learning (deep learning) using this second training data that has been input, and generates a second inference model. It should be noted that the population creation section 302 creates a population for second learning using the second training data, and the input output modeling section 304 may perform second learning using this population. It should be noted that as was described previously, test data may be used directly as second training data, and in this case a second inference model is generated based on metadata MD that is stored in association with second training data. Since a learning spec such as purpose is stored in the metadata MD, the second inference model may be generated based on this learning spec.

Once the learning section 300 has generated the second inference model, inference is performed by the inference engine for the second learning result (S17). Once inference has been performed, this flow is terminated.

In this way, with the second embodiment, with operation of the learning request system first, first training data is created, and then a first inference model is generated by performing deep learning using this first training data (S1, S3). Inference is then performed for images using this first inference model, and images in the case where inference results in failure are made into test data candidates (S5 to S11). If the test data candidates reach a specified number, training data is recreated using this data, and a second inference model is generated using this training data that has been recreated (S13, S15). In this way since relearning is performed using training data that has been recreated, it is possible to perform inference of high reliability.

Also, as was described previously, if an image has no confidentiality etc., it is possible to directly take test data candidates as test data and second training data at the time of shooting (refer to FIG. 14). In this case, steps S9 and S11 are skipped, and in step S13 second training data is generated based on metadata MD data stored in association with the second training data. Since a learning spec such as purpose is stored in the metadata MD, the second inference model is generated based on this learning spec (S15).

Also, the flowchart for the learning request system of this embodiment has a step of acquiring a learning model for true or false judgment that is generated based on a first request (refer to S1 and S3). Specifically, in this flowchart, the camera 100 or the learning request section 200 generates first training data (which is part of the information of the first request) in the learning section 300, and generates an inference model (learning model) based on this first training data. Also, the flowchart of the learning request system has a step of inputting specified test samples to a learning model and performing true or false judgment (refer to S5 and S7). Specifically, with this flowchart, a learning model (inference model) that has been input from the learning section 300 is used in true or false judgment (refer, for example, to NG judgment for in frame 2b of FIG. 2, OK and NG judgments of the inference engine 205 in FIG. 4, and to S5 and S7 in FIG. 6). Also, the flowchart of the learning request system has a second request generation step for creating a second request in accordance with true or false judgment results (refer to S9, S11 and S13). Specifically, in this flowchart, second training data (which is part of the second request information) is created in accordance with results of true or false judgment, and relearning is requested to the learning section 300 (refer, for example, to frame 2c in FIG. 2, image choosing, image processing etc. and S9, S11 and S13 in FIG. 4). This second request creates information other than test samples. Specifically, in this flowchart true or false judgment is performed using test samples, and the second request creates information other than test samples (for example, second training data).

It should be noted that the second inference model may be transmitted to the camera 100 by means of the learning request section 200, and may be transmitted directly from the learning section 300 to the camera 100. Also, a first inference model may be transmitted to the camera 100, and failure data of steps S5 to S9 accumulated in the camera 100, and the learning request section 200 may create second training data using this failure data.

Next, operation of the training data recreation in step S13 will be described using the flowchart shown in FIG. 15. This processing is executed by the control section 201 within the learning request section 200. It should be noted that as was described previously the control section 101 within the camera 100 may execute this processing using images that were acquired within the camera 100. The flow for training data recreation shown in FIG. 15 is only the additional step S22 to the flowchart of FIG. 7 for the first embodiment. Since substantially the same processing is executed with processing of the same step number, steps for the same processing as in the first embodiment will be described simply, and description will mainly be given for characteristics of the second embodiment.

If the flow for training data recreation is commenced, first, first training data and test data candidates are acquired (S21). Next, if there is no confidentiality etc. in images, namely if there is no hidden reference data, additional training data is acquired (S22). Here, images that have been newly acquired at the shooting scene, or images that have been transmitted with the fact that they will be used in learning by the user, are made directly into first training data. Since the file creation section 101ab of the storage control section 101a creates an image file by associating metadata with images, it is possible to use this metadata as information for image classification.

Next, contribution of similar images of test data candidates using first training data is increased (S23). Next, contribution of images of low similarity of test data candidates of the first training data is reduced (S25). Next, addition of negative samples is performed, and the negative samples are made into training data of similar images of the test data candidate (S27). If similar images of test data candidates are made into training data, this flow is terminated and the originating flow is returned to.

Next, operation of individual devices of the learning request system will be described using FIG. 16A to FIG. 17. First, operation of the camera 100 will be described using the flowcharts shown in FIG. 16A to FIG. 16C. This operation is executed by the control section 101 within the camera 100 in accordance with a program that has been stored in memory. The flow for camera control shown in FIG. 16A to FIG. 16C is only the addition of steps S30, S54, S58, S66a, and S66b to the flowcharts of FIG. 8A and FIG. 8B for the first embodiment. Since substantially the same processing is executed with processing of the same step number, steps for the same processing as in the first embodiment will be described simply, and description will mainly be given for characteristics of the second embodiment.

If the flow for camera control shown in FIG. 16A is commenced, first a specification is set (S30). Here, specification for when creating an inference model is set based on metadata MD that is stored in association with image data. As this metadata there is the information of (a) to (g) and (1) to (7) described previously, in summary, such as (1) purpose, (2) is determination for an image or an event, (3) is determination subjective or objective, (4) determination timing (before shooting, at the time of shooting, after shooting), (5) associated image group information, (6) is determination for an entire image, partial image, or a physical object, (7) will the image data be made training data or made test data (hidden reference data) etc. It should be noted that the specification can also be set in step S66a, which will be described later.

Also, in step S30, if there is a failed image, a specification may be made so as to reflect that image. Further, if there is an increase in defective images for which inference is bad, a specification may be set in order to acquire a new inference model. In order for the user to confirm content of a specification, specification content may be listed on the display section 106. Using the list display, it is possible to confirm at a glance whether or not the user's needs are reflected.

If a specification has been set, it is next determined whether or not it is shooting mode (S31). If the result of determination in step S31 is that shooting mode has been set, images are input (S33). It is next determined whether or not to activate an inference engine (S35). If the result of determination in step S35 is that the inference engine has been activated, inference is performed (S37). If inference has been performed, it is next determined whether or not reliability is higher than a predetermined value (S39).

If the result of determination in step S39 is that reliability is not high, it is determined whether or not it is scene that should be detected (S45). The fact that reliability is low is a case where the inference model detecting that original scene is not expected. In the case of scene for which an inference model that has been set is not particularly suited (a scene that is out of the area of expertise for that inference model), it is to be expected that reliability will be low. In this step the user may visually determine whether or not there is a scene that should be detected, and if it is possible to perform determination by image analysis, the results of that analysis may also be used. Image P24 in FIG. 3B is an example where it fails in detection even if it is a scene that is supposed to be detected. Since such images are desired to be inferred correctly, they are stored as an image file such as shown in FIG. 14, and may be made training data or reference candidate data in a re-learning request. Accordingly, that fact is described in metadata as annotation reference for learning. With the learning request device and learning device learning that has used this image becomes possible based on this image data. Since an image is extremely specific, it has already been described that designation of learning by using image is logical.

If the result of determination in step S45 is that there is a scene that should be detected, this image is stored, and made training data or a test data candidate for a re-learning request (S47). If an image has been stored as training data or a test data candidate for a re-learning request in step S47, or if the result of determination in step S45 is that it was not a scene that was supposed to be detected, or if the result of determination in step S35 is that the inference engine is not activated, various parameters are controlled so that it is photographed averagely over the entire screen (S49).

Returning to step S39, if the result of this determination is that reliability is high, detection results are displayed (S41). Once detection results have been displayed, next various parameters are controlled based on the detection results so as to appropriately take photographs (S43)

If parameters have been controlled in step S43 or S49, it is next determined whether or not there is movie shooting or still picture shooting (S51). In this step, it is determined whether or not an operation to instruct shooting has been performed. If the result of this determination is that a shooting instruction has not been performed, processing returns to step S30. It should be noted that if the specification setting is not required, step S30 is skipped, and step S31 may be returned to instead (the same applies in a case where a determination result in step S55, which will be described later, is No, and after S58 has been executed).

On the other hand if the result of determination in step S51 is that a shooting instruction has been performed, shooting is performed and image data is stored (S53). If image data has been stored, next attaching of metadata is performed and an image file is created (S54). If test data candidates are acquired at the time of shooting, test data or training data is created directly. If performing this processing is set in step S54, it is executed. Also, as metadata there are the previously described (1) to (7) ((a) to (g)) etc. and the file creation section 101ab associates this metadata with image data to create an image file.

Once an image file has been created, it is next determined whether or not there has been a scene that was supposed to be detected but failed in detection (S55). In this step, it is determined whether or not there was not detection using inference, even if there is a scene that should be detected at the time of shooting in step S53. If the result of this determination is No, processing returns to step S30.

If the result of determination in step S55 is that inference has failed in detection even if it was a scene that was supposed to be detected, the image is made training data or a test data candidate for relearning (S57). Here, similarly to step S47, image data that was photographed in step S53 is stored as training data for relearning or as test data. If determination as to whether or not a good image has been taken can be performed with image recognition technology etc., a reference time for this image is made 0 since this is a decisive moment, and the image data may also be made training data or test data for prediction by allocating an earlier time to images that have been acquired by that time.

Once the image data is made test data candidates, metadata is then attached thereto (S58). As was described using FIG. 14, if test data candidates are acquired at the time of shooting, test data or training data may be created directly. Also, since there are cases where the precise moment it is intended to take a picture is displaced due to response delay, reflex action or other eventuality, it may be possible to perform correction of reference time. This type of correction can also be performed at the time of playback, and images that were acquired previously may have the corresponding correction time attached as metadata. If metadata attachment processing is set in step S58, this step S58 is executed. Also, as metadata there are the previously described (1) to (7) ((a) to (g)) etc. and the file creation section 101ab associates this metadata with image data to create an image file. Once this processing has been performed, processing returns to step S30.

Returning to step S31, if the result of determination in this step is not shooting mode it is determined whether or not an inference model etc. is to be acquired (S61). If the result of determination in step S61 is not that an inference model will be acquired, playback mode etc. is executed (S71). Once playback mode etc. has been executed processing returns to step S30.

On the other hand, if the result of determination in step S61 is to acquire an inference model etc., next it is determined whether or not to request using own device (S63). If the result of determination in step S63 is not to request using own device, mediation as requested (S73). In this case, the camera 100 requests mediation for generation of an inference model to the learning request section 200, by means of the communication section 107 and the communication section B203 within the learning request section 200. At this time, test data candidates that were stored in steps S47 and S57 are also transmitted. If mediation has been requested, the learning request section 200 performs processing similar to the flow that was shown in FIG. 15 to create second training data (refer to S101 and after in FIG. 17). Once mediation has been requested step S30 is returned to.

If the result of determination in step S63 is to request using own device, the number of test data is determined (S65). As was described previously, training data for relearning and test data candidates are stored in steps S47 and S57. In this step, training data for relearning and test data candidates that are stored are counted. It should be noted that although an example of acquiring test data generally in a field has been described, obviously there are also users who want to use test data not for testing but as training data as a priority, and therefore training data for relearning may be set similarly to test data.

If determination of the number of test data has been performed, next a specification is set (S66a). Here, specification setting is performed, similarly to step S30. Specifically, at the time of requesting learning for inference model creation from the camera 100 to the learning device 300, a specification as to what type of inference model will be generated is set. As specifications, for example, there are desired delivery period (time) until an inference model is acquired, and inference time and power consumption etc. needed for inference. Other specific examples of specification will be described later using FIG. 21 and FIG. 22.

If the specification has been set, next metadata is attached (S66b). Here, if they are images to which metadata has not been attached in steps S54 and S58, metadata is attached. The learning device 300 generates an inference model based on this metadata.

Next, it is determined whether or not there is a need for relearning and whether relearning will be requested (S67). In the event that the number of training data for relearning or test data candidates is greater than a specified number, the inference model that is currently being used becomes no longer suitable due to change in shooting environment, change in photographing materials etc. Also, there are cases where the user wishes to acquire a completely different inference model to the inference model that is currently set. In this step it is determined whether or not relearning is required based on these conditions.

If the result of determination in step S67 is that relearning is required, and acquisition of an inference model using relearning is requested, training data is recreated and relearning is requested (S69). Here, second training data is created taking into consideration the training data for relearning and the test data candidates, similarly to the flowchart that was shown in FIG. 15. This data has metadata for an image, and the metadata includes a spec for machine learning and annotation information, or annotation correction information, and may be transmitted with a requirement specification as well. Some or all of this information is entered into metadata of the image. Once second training data has been created, the second training data is transmitted to the learning section 300 by means of the communication section 107, and relearning is requested. Also, at this time correction of annotation information may be performed on images. Requirement specification at the time of inference model generation may also be transmitted.

On the other hand, if there is no relearning required request in step S67, it is next determined whether or not there is acquisition (S75). If the result of this determination is not acquisition, processing returns to step S30. If the result of determination in step S75 is acquisition, acquisition of a new inference model is performed (S77). If the new inference model has been acquired, processing returns to step S30.

In this way, in the flow for camera control, inference is performed on images that have been acquired by the imaging section 103, using the inference engine 104 (S37). In a case where reliability of this inference result is low, the inference engine 104 determines whether or not there is a scene that should be detected, and if there is a scene that should be detected image data at this time is stored as test data candidates (refer to S39 No, S45 Yes, and S47). When shooting has been performed also, if detection was not possible using inference, even if there was a scene that should be detected, image data at this time is stored as test data candidates (S55 Yes, S57). In a case where relearning is required, the image data that has been stored as test data candidates is used when recreating training data (refer to S67 Yes, S69). This means that in cases where an inference model is no longer optimal, due to changes in photographed object and shooting material, it becomes possible to generate an inference model of high reliability.

Also, at the time of shooting, annotation is performed in image data (refer to S54 and S58). Specifically, as was described using FIG. 14, at the time of shooting metadata is attached to image data. As a result, it becomes easy to create training data and to perform a request for relearning such that it is possible to perform inference of high reliability. In particular, since annotation is performed at the time of shooting, it becomes possible to perform a request for relearning rapidly.

The flow for the learning request system shown in FIG. 9 executes substantially the same processing in the second embodiment also, and so descriptions in FIG. 9, as the second embodiment, will be adopted and detailed description is omitted. Here, operation relating to the second embodiment will be described. If the flow for the learning device shown in FIG. 9 is commenced, it is first determined whether or not a learning request has been received (S81). If the result of determination in step S81 is that a learning request is received, next a requirement specification is acquired (S83). At the time of receiving a request for generation of an inference model using deep learning, a requirement specification for an inference model is transmitted from the transmission source. In this step, a requirement specification from the transmission source is received and stored. Here, at the time of recreation, when inference is also output, learning spec acquisition may also be performed by referencing metadata of an image file that has been transmitted as training data. As was described previously, this may be executed at the time of a learning request (refer to S1 in FIG. 6).

Next, training data is acquired (S85). If training data has been created, next an inference model is generated (S87). If the inference model has been generated, it is next determined whether or not the inference model satisfies the requirement specification (S89). If the result of determination in step S89 is that the requirement specification is not satisfied, the training data is reset (S91). Once the training data has been reset, it is determined whether setting of the training data has been performed more than a specified number of times (S93). If the result of this determination is not greater than a specified number of times, processing advances to step S87. On the other hand, if the result of determination in step S93 is that the number of times the training data has been reset is greater than the specified number of times, difficult to handle image information etc. is transmitted (S95). If the result of determination in step S89 is that the requirement specification has been satisfied, or if difficult to handle image information etc. has been transmitted in step S95, an inference model is transmitted to the requesting unit (S97). If an inference model has been transmitted, processing returns to step S81.

In this way, with the second embodiment also, in the learning device, in a case where there is a learning request, an inference model is generated in accordance with a requirement specification (S83, S87), and once an inference model has been generated it is transmitted to the requester (S97). Also, in a case where reference training data has been transmitted from the requester, an inference model is generated by creating a population (training data) that includes this reference training data, and is comprised of data that is similar to the reference training data. In a case where second training data has been transmitted from the camera 100 or the learning request section 200 also, an inference model can obviously be generated in the same way as for with first training data.

Next, operation of the learning request device will be described using the flowchart shown in FIG. 17. This flow is implemented by the control section 201 within the learning request section 200 based on programs have been stored in memory. It should be noted that this flow is not limited to being executed in the learning request device, and may also be executed by devices other than the learning section 300 and the camera 100, for example, by an external unit such as a PC or smart phone. It should be noted that the flow for the learning request device shown in FIG. 1 is only the addition of step S104 to the flowchart of FIG. 10 for the first embodiment. Since substantially the same processing is executed with processing of the same step number, steps for the same processing as in the first embodiment will be described simply, and description will mainly be given for characteristics of the second embodiment.

If the flow for the learning request device shown in FIG. 17 is commenced, it is first determined whether or not there is a mediation request (S101). If the result of determination in step S101 is that there is a mediation request, test data candidates are acquired (S103).

Next, determination of new training data is performed (S104). In this step it is determined whether training data for relearning and test data have been added, and if training data and test data have been acquired data to be associated with image data, such as metadata, is determined. Addition of training data can be considered to be an indication that the user is eager to have an inference model that has been improved by means of learning again for an actual scene. This may be by manual selection, and may be automatic in order to support users who are not too concerned about portrait rights etc., and training data may be automatically transmitted as test data, taking in to consideration information such as copyright and portrait rights, and individual information etc. If notification to that effect is performed, the user will also take care with these items of information.

Also, confirmation of specification is also performed in step S104. As specification, specification such that causes of failure of test data that was added as failure images are reflected is added. It should be noted that in order to make an inference model that has incorporated the user's needs, other specification may be reflected. Specific examples of specification confirmation will be described later using FIG. 21 and FIG. 22.

Next the number of test data candidates is determined (S105). It is next determined whether relearning needs to be requested (S107). As was described previously, in the event that the training data for relearning and test data candidates are greater than a specified number, the inference model that is currently being used becomes no longer suitable due to change in shooting environment, change in photographing materials etc. Also, there are cases where the user wishes to acquire a completely different inference model to the inference model that is currently set. In this step it is determined whether or not relearning is required based on these conditions. Also, in a case where training data has been acquired, determination is performed so as to perform relearning in such a manner that the training data contributes to producing correct inference results.

If the result of determination in step S107 is that relearning is required, and acquisition of an inference model using relearning is requested, training data is recreated, and if recreation was possible generation of an inference model is requested (S109). In step S103, if, among test data candidates that have been acquired, metadata representing purpose information that has been designated is for prediction, image data having retroactive time attached as annotation information is collected, and then generation of an inference model is requested by providing this image data that has been collected as a training data group.

On the other hand, if there is no need to perform relearning in step S107, it is next determined whether or not there is acquisition (S111). If the result of this determination is not acquisition, processing returns to step S101. If the result of determination in step S111 is acquisition, acquisition of a new inference model is performed (S113). If a new inference model has been transmitted, processing returns to step S101.

In this way, in a case where the learning request section 200 has requested intermediation for acquisition of an inference model from the camera 100 (S101 Yes), training data for relearning and test data candidates are acquired from the requester, and whether or not relearning is required is determined based on the number of the data (S105, S107). In the event that relearning is required, training data (second training data) is created based on training data for relearning and test data candidates, and this training data is transmitted to the learning section 300 (S109). The learning section 300 generates an inference model by deep learning based on this training data (refer to S85 and S87 in FIG. 9).

With the second embodiment also, it is possible to apply a method of generating similar image data to training data using a GAN that was described using FIG. 11 in the first embodiment. As the second embodiment, descriptions in FIG. 11 will be adopted and detailed description is omitted.

Next, an example where annotation (attachment of metadata) is performed at the time of shooting will be described using FIG. 18A and FIG. 18B. This is a modified example of the example of associating metadata with image data at the time of shooting, that was described using FIG. 14. With the example shown in FIG. 13, FIG. 14, FIG. 3A and FIG. 3B, inference for a photographed physical object itself within an image was described. With the example shown in FIG. 18A and FIG. 18B, an example of inferring a relationship between an image and an act occurring in that image will be described. That is, an image is not for observation or storage, but is used as an image indicating conditions that will cause an act that will occur from now on. Specifically, images are utilized for learning in order to predict what, that has been actually shown in an image, would lead to (what type of event).

The example shown in FIG. 18A and FIG. 18B is imaging a view in a vehicle travel direction, and uses a digital camera 100 in a so-called drive recorder. As shown in FIG. 18A, a driver is driving a vehicle, and a camera 100 that monitors in front of the vehicle is arranged. In a case where a cat 413 appears within the shooting field of view of the camera 100 at a specified time, at a specified size, and at a specified location (and in a case where the direction of the cat 413 is facing in the direction of travel) there is a possibility that it will be necessary to brake suddenly. The possibility of that type of action being required also changes in accordance with speed of the cat 413 and vehicle etc. With this embodiment, therefore, posture 413 etc. of a cat depicted in an image that has been acquired by the camera 100 is inferred using AI, and level of danger is notified.

If a photographing lens of a particular specification is assumed, size of the cat 413 within a taken image constitutes distance information. Acceleration that is characteristic of sudden braking is detected using an acceleration sensor (G sensor) that is built into the camera 100, or built into the vehicle. A graph described within frame 18a in FIG. 18 shows time on the horizontal axis, and change in acceleration on the vertical axis. Also, the upper part of the graph has images that have been acquired by the camera 100 arranged in order of flow of time. In this drawing, time 0 sec is a time at which the driver senses danger and applies sudden braking, and time (−Y sec) is a time Y sec before 0 sec, and constitutes a reference.

In a case where there is this type of acceleration change, information such as acceleration information is stored in an image that has been captured. 18b of FIG. 18 shows training data (image file) for danger notification in which this information has been associated with the image P31 as metadata MD1. 18c in FIG. 18 shows an example of creating an inference model with the image P31 that has (acceleration change) information attached as training data. With an inference model that has been acquired with this type of training data, it is possible to provide a vehicle mounted system in which prediction of sudden braking is conveyed to the user in advance using voice or display etc., and the user is encouraged to be ready to take evasive action, as shown in FIG. 18A.

Frame 18b in FIG. 18 shows a structural example of metadata (file) MD1 when an image (an event represented by an image) in which detection is desired with this type of scene is put into an image file, and made into metadata as training data, or when made into (metadata) as test data. Although it is a simplified structural drawing, an example of several items of main written information is shown in frame 18b of FIG. 18. Since it is an example in which the purpose is “prediction” (of an accident etc.) and caution should be exercised, “NG is set”. Accordingly, since this image does not appear to be for a purpose of confirming quality etc. of that image itself, this image is recognized for learning of some “event”. Also, due to not being a subjective determination but rather an objective consideration, such as that an event such as sudden braking may occur, the fact that it is “objective” is shown. Also, because a continuously occurring event is learned, rather than an event at this time, time is made “3 seconds”. That is, metadata of this type of image requires a scheme such as attaching metadata to an image again after the lapse of 3 seconds. Also, although not illustrated, information regarding whether to make training data for externally requested learning, or to make hidden reference data, may also be created in the metadata MD1.

It is possible to generate an inference model by performing deep learning in the network design 304d within the input output modeling section 304 shown in 18c of FIG. 18, with image data that has been associated with metadata, such as shown in frame 18b in FIG. 18 as training data. This inference model can perform warning of the fact that danger is imminent, for images of time (−Y sec).

Next, another example where annotation (attachment of metadata) is performed at the time of shooting will be described using FIG. 19A and FIG. 19B. FIG. 19A and FIG. 19B are an example of prediction-related learning, similarly to that of FIG. 18A and FIG. 18B. Although FIG. 19A and FIG. 19B have the same basic idea as FIG. 18A and FIG. 18B, prediction is performed with an inference model not assuming an accident, but for whether or not there is a shooting opportunity for images that might constitute “models”. Accordingly, it can be said that an event such as a shooting opportunity is predicted. Therefore, depending on whether or not an image of a cat, which is a physical object depicted in an image, can be taken, metadata for image prediction is associated with image data.

There may be a case it is possible for an owner to predict, from how the cat is walking, if the cat will next sit down or lie down, for example. It can be considered that this type of prediction can be inferred, and would constitute valuable information for users other than the owner. If such inference is not available, without knowing whether or not it is worth waiting, a shooting opportunity will only be lost. Generally speaking, a photograph of a cat being curled up is made a model image because such a posture is popular among cat photographs. Even if an image is not necessarily a good image, those images would be of use for camera makers as reference samples or the like for a desired image to be photographed.

FIG. 19A and FIG. 19B are an example of conveying whether or not a time at which an image when a cat is coiled up is possible is approaching, to the user. As a result, it is possible to reduce fruitless waiting time of the user etc. FIG. 19A shows appearance of the user taking a picture of the cat 413 using the camera 100. Frame 19a in FIG. 19B shows taken images arranged in time series, and shows change in degree of satisfaction over time for the images at that time of shooting. Time (−Xsec) represents a reference time, and 0 sec represents a time where degree of satisfaction of the user for an image becomes high.

Examples of metadata for training data that have been associated with image data are shown within frame 19b and frame 19c in FIG. 19B. Image P32 that was taken at time (−Xsec) is shown within frame 19b in FIG. 19B. Metadata MD2 for training data is created, and associated with data of image P32. Image P33 that was taken at time (0 sec), which is the reference time, is shown in frame 19c of FIG. 19B. Metadata MD3 for training data is created, and associated with data of image P33.

An image itself of a decisive moment of shooting constitutes training data implying “it is an image taken by a user at their own volition”, and so metadata is described as a subjectively OK image. Similarly to FIG. 18A and FIG. 18B, an image obtained at time (−Xsec) before actual shooting is made into an image file as in frame 19c in FIG. 19, similar to that within frame 18a in FIG. 18, so that learning, so as to be able to predict a future that it is desired to infer under particular conditions, is possible. A file structure example when making this image file into training data, or making this image file into test data, is shown in the metadata here. It should be noted, regarding whether or not there is a risk of or a feeling of resistance to images being leaked outside, determination by the user between training data and reference data to be made, may be by manual setting or voice input. Regarding portrait rights, if there is no problem with a cat as a physical object, but there is a problem with a person as a physical object, such judgment may be performed automatically or manually. It is possible to determine if a physical object is a person or not a person using face detection. If the physical object is a person, correction so that it is no longer possible to recognize that person may be applied, and the person may be made in to an avatar when making training data.

Within frames 19b and 19c in FIG. 19, a simplified structure is shown, and examples of several items of main written information are shown. Since it is for indicating an example with good a sign such as “the best shooting opportunity is coming up”, OK is set. Accordingly, this image appears to be for confirming quality of that image itself, and it is therefore recognized as “it is for some kind of image-related learning”. Also, since the best photograph is dependent on a subjective judgement, “subjective” is set. Timing information such as shown in frame 19b of FIG. 19 is set to 0 for an image at the best photo timing itself. In a file of an image shown within frame 19c in FIG. 19 associated with chances that will occur from now on, timing is set to, for example, 3 seconds later, in order to use such information in learning for obtaining an inference model not something for this shooting timing, but for something occurring next, such as shown in frame 19d in FIG. 19. Also, although not illustrated, information regarding whether to make training data for externally requested learning, or to make hidden reference data, may also be created in the metadata MD1. That is, in creating this type of image file also, metadata of this type of image requires a scheme such as attaching metadata to an image again after the lapse of 3 seconds.

If an image file for shooting guidance, such as shown in frames 19b and 19c in FIG. 19, is created, it is possible to generate an inference model by performing deep learning in the network design 304d within the input output modeling section 304 shown in frame 19d of FIG. 19, with image data that has been associated with this metadata as training data. This inference model can present advice as to how long it is best to wait until the best timing, for an image at time (−xsec).

Next, control operations for a camera that is capable of attaching metadata, such as shown in FIG. 18A, FIG. 18B, FIG. 19A, and FIG. 19B, will be described using the flowcharts shown in FIG. 20A and FIG. 20B. This operation is executed by the control section 101 within the camera 100 in accordance with a program that has been stored in memory.

The operations of FIG. 18A to FIG. 19B constitute training data so as to perform learning for an event occurring subsequent to shooting, not for an event occurring at the time of shooting. For this reason, when creating an image file it is necessary to devise a scheme whereby metadata of an image is attached to an image again after the lapse of a predetermined time. The flowcharts shown in FIG. 20A and FIG. 20B implement camera control (file creation device) that is capable of this type of metadata attachment. Also, in FIG. 16A to FIG. 16C portions within an image that the user wanted to detect were learned, and so other information was not used. However, in this flowchart other sensor information such as acceleration information etc. is used and referenced as shown in FIG. 18A to FIG. 19B. These items of information may be associated with built-in sensors provided in the camera 100, and may be associated with sensors within other devices using IoT.

In this way, a camera, as an image file generating device that is mounted in a vehicle or is handheld, and generates an image file made up of training data candidates, has a processor that comprises a metadata generating section that generates metadata in order to designate whether purpose of an inference model that is learned using training data is inference for predicting change in images that are continuous in time series, and is capable of determining metadata based on information corresponding to time before and after images have been acquired. These types of images that change over time constitute effective training data because they indicate condition change in accordance with conditions. There is no limitation to using these images as training data and they may also be applied as test data. With this embodiment, a structure where an imaging section and file generation are in the same unit is assumed, but they may be in separate units.

In the following, description of the flowcharts of FIG. 20A and FIG. 20B will be given, but processing that is basically the same at that of FIG. 16A to FIG. 16C will described in a simplified manner.

If the flow shown in FIG. 20A is commenced, it is first determined whether or not there is shooting mode (S121), and if this determination result is shooting mode image input etc. is performed (S123). Here, images are acquired by the imaging section 103, and acceleration information etc. is input using other sensors, as previously described. Further, in order to measure change over time, as shown within frame 18a in FIG. 18 and within frame 18a in FIG. 19, a clocking operation is commenced. Also, a number of frames that have been acquired by the imaging section 103 is stored. It should be noted that shooting may be movie shooting, and may be continuous shooting.

Once image input etc. has been performed, it is next determined whether or not there is an association dictionary (S125). An association dictionary is an inference model corresponding to scenes that have been photographed with the camera, and determines whether an inference model that is suitable for a current photographed object is set in the inference engine 104. It should be noted that in the flow shown in FIG. 16A, determination as to whether or not an inference engine is activated was performed. Similar determination may also be performed in this step S125 also.

If the result of determination in step S125 is that there is an association dictionary, inference is executed (S127). Here, image data that was acquired in step S123 is input to the inference engine 104, and inference is executed. Next, reliability of results of inference are determined (S129). If the result of this determination is that reliability is high, guidance display is performed (S131). Here, warning display and shooting guidance, such as shown in FIG. 18A and FIG. 19A, are displayed.

Once guidance display has been performed, it is next determined whether or not there are features in sensor output (S133). Here, the sensor output that was input in step S123 is referenced, and it is determined if there are features in sensor output, or if it is possible to infer a particular event from characteristic variation patterns. It should be noted that determination is not limited to using sensor output, and may be based, for example, on results of image analysis, such as a cat having entered an image. If the result of determination in step S133 is that there are features in sensor output, creation of a reference time is performed (S135). Here, a reference time is automatically set so that a time at which a particular event occurred becomes a reference time, and after that it is made possible to clock time from this reference time.

If reference time has been set, next storage of temporal result correction for stored images, purpose determination, sensor information, event, and other specifications etc. is performed (S137). This processing performs storage of metadata with sensor output as a trigger. Specifically, time information is additionally stored in metadata of an image that is already stored. In this step S137, sensor output information itself, and event information that has been obtained therewith, can be stored as metadata. Regarding temporal result correction for stored images, if reference time has been determined in step S135 for images that are stored in time series, images are organized in order of elapsed time from that reference time. Also, purpose is set from a specification etc. For example, in a case where information characteristic to sudden braking has been obtained from an acceleration sensor, velocity sensor, change information in position information sensor, etc., a description regarding this event having been detected as a result of what happened with which sensor, etc., may be stored. Storage in this step may be performed manually by the user, but in a case where they are features in sensor output the storage is best performed automatically.

If storage has been performed in step S137, or if the result of determination in step S133 is that there are no features in sensor output, it is next determined whether or not it is still picture shooting (S139). Here, conditions for performing shooting are not necessary a relay switch operation, and may be due to the effects of sensor data etc. In this case, in step S139 whether still picture shooting has been determined may be stored as a result of any operation. Metadata of the image file changes as a result of images being associated with an event that has been detected as a result of this type of sensor data or operation.

If the result of determination in step S139 is still picture shooting, shooting is performed, and image data that has been acquired as a result of shooting is stored (S141). Next, creation of reference time is performed, similarly to step S135 (S143). There will be cases where the user has operated a release button etc., and organization of images is performed by making this time a reference. Next, similarly to step S137, temporal result correction of stored images, purpose determination, sensor information, event, and other specifications etc. are stored (S145). In the case of taking a photograph in which a cat is coiled up, that was described in FIG. 19B, the reference time may be set to the release timing, and set in this step S145. As a result of these processes it is possible to create an image collection immediately before sudden braking, as was shown in FIG. 18A and FIG. 18B, and it is possible to make training data constituting big data. Storage of metadata here may be performed manually by the user, but storage can be performed automatically by the camera.

If step S121 is returned to and the result of determination in this step is that it is not shooting mode, it is next determined whether or not the camera is in playback mode (S151). If the result of this determination is playback mode, this display is performed (S153). Here, image data that is stored in the storage section 105 is read out, and subjected to this display on the display section 106. Next, selection playback is performed (S155). Since the user selects magnified display from within the list display, in this step it is determined which image is selected.

Next it is determined whether or not a favorite operation has been performed (S157). With this embodiment, if the user themselves or a person who has been confirmed, wants to store timing of an event while looking at a stored image that has been played back by the user, a favorite operation is performed using the operation section 102. In this step, it is determined whether or not this operation has been performed. In the event that a favorite operation has been performed, reference time is set (S159). Here, time (timing) that has been stored in a playback image is made reference time, and where this reference is set is input. Next, temporal result correction, purpose determination, sensor information, event and other specifications for each image that is stored, is stored (S161). The same metadata is stored in both steps S137 and S145, but in this step manual input by the user is the main approach. Obviously, metadata that is stored in a playback image may be maintained, and only manually input metadata may be rewritten.

Returning to step S151, if the result of determination in this step is that it is not playback mode, it is next determined whether or not there is a request for an inference model (S163). It is determined whether or not an inference model has been requested from the camera 100 to the learning section 300 directly. If the result of this determination is that an inference model is requested, physical object of the inference model is specified (S165), and learning is requested to the learning section 300 in order to generate an inference model (S167). Here, images with metadata may be transmitted from the communication section 107 to the learning device as training images for specific event prediction. In this case, the file creation section 101ab (metadata assignment section) may attach and transmit information about whether or not a specified event is an event the user should be made aware of, as metadata.

If the result of determination in step S163 is that there is not a request for an inference model, it is determined whether or not to acquire an inference model (S169). If learning is requested to the learning section 300 in step S167, the learning section 300 generates an inference model and transmits the inference model to the camera 100. Here, it is determined whether or not to acquire an inference model to return. If the result of determination in step S169 is to acquire an inference model, an inference model is acquired and stored (S171). This newly acquired inference model is like a worker who has experienced quite intense on-the-job training, and constitutes an improved inference model that a practical user desires, and satisfaction of a user who uses this inference model is further improved. In the case of sufficient improvement, setting may be performed so that additional learning is not performed. This may also be possible to describe in metadata. Also, it can be considered that as a result of performing too much additional learning, it will instead result in an inference model having a specification that is different to the intended aim. It is therefore better to perform version management of the inference model, so as to return to a previous version. At the time of this type of additional learning, there is also a problem such as what version is being added to, but this may also be described in metadata. It is also possible to adopt a solution such as storing a version of the inference model that is in use as metadata. In order to manage metadata, when requesting additional learning by transmitting an image file that has been generated to an external learning device, the file creation section 101ab (metadata assignment section) may attach identification information indicating an inference model to which additional learning has been applied.

The operations of this flow have a lot of processing that is the same as that in FIG. 16A to FIG. 16C, and sections that have been described in detail will be shown simplified. For example, although sections for specification setting etc. may be initially performed (making specifications for sudden braking prediction at the time of using a drive recorder etc.), in this flow sections such as being able to perform manual input at the time of creating an image file are emphasized (user may perform setting at times of S137, S145, S161 etc.). Also, in a case where any inference can be made based on images that were input in S123, guidance display is performed in S131. In this case, in a case where there is an inference model for association (dictionary) and reliability is high, only results that are worth displaying are used in guidance display. Also, description relating to movie storage has been simply omitted here, and the same approach as in FIG. 16A to FIG. 16C can be adopted.

As has been described above, with the second embodiment of the present invention, an image file having image data and metadata is generated. Then, when creating an inference model that is input with images associated with image data, (1) purpose information for designating purpose of the inference model and (2) information as to whether the image data will be made into training data for externally requested learning, or made into hidden reference data, is attached as the metadata. As a result, with this embodiment it is possible to generate an image file used at the time of requesting learning, so that it is possible to perform inference of high reliability. It should be noted that only one of the information of (1) and (2) may be attached as metadata.

Also, with the second embodiment of the present invention, besides the above described (1) and the above described (2), at least one of (3) whether what is being determined is an image or a phenomenon, (4) whether determination is subjective or objective, (5) determination timing, (6) associated image group information, and (7) information as to whether determination is for an entire image, part of an image or a physical object, is attached as metadata. As a result, since these items of metadata are attached to images, when performing machine learning using these images it is possible to perform high reliability learning.

Also, the image file device of the embodiments of the present invention is an image file generating device that is used in input of inference, and this image file generating device generates an image file having image data and metadata. This image file generating device, comprises a processor having a metadata assignment section, wherein the metadata assignment section, when creating an inference model that is input with images that are associated with the image data set as a training data candidate, assigns at least one of (1) classification information for designation classification of the inference model, (2) information as to whether what is being determined is an image or an act, (3) information as to whether what is being determined is determination is based on a subjective determination or based on an objective determination, (4) information on time-related timing for determination, and (5) information as to whether what is being determined is an entire image, partial image or a physical object, as the metadata. Here, the expression “specified physical object” in (5) is abstractive, and may be a physical object ‘that has been designated” by the user.

Next, a modified example of setting specification of the first embodiment and second embodiment will be described using FIG. 21 and FIG. 22.

FIG. 21 is an explanatory drawing showing one example of specification setting menu display that has been displayed on a display screen of the display section 106. This specification setting menu display corresponds to the metadata MD in FIG. 14, the metadata MD1 in FIG. 18, and the metadata MD2 and MD3 in FIG. 19. With the example of FIG. 21, there are 15 specification items contained within the specification information, but specification items can be appropriately set. The example of FIG. 21 shows specification items of specification information for creating an inference model for detecting a specified detection target within an image.

In the case of creating an inference model there are many cases where much more complicated events are determined compared to cases where determination with a logic base is performed, and there is therefore a need to use various hardware and software restrictions, and various training data, and it is further preferable to be able to easily handle correction in accordance with conditions etc. Accordingly, in a case where a specification list such as shown in FIG. 21 is not displayed, it is easy for oversights to occur, such as use without knowing what detrimental effects may occur, or learning requests being mistakenly generated. Main parts of a specification information list will be described in the following.

The detection object item is information indicating that detection object information indicating a detection object has been attached to training data as annotation. The hardware information item shows information relating to a unit that uses an inference model, is for designating number of network layers, clock frequency, and memory capacity of the unit. The response time item is for designating a time from image input to inference output. With the example shown in FIG. 21, the correct solution rate and reliability item is for designating that reliability of inference of greater than 90% will be confirmed, and the input image size and other item is for designating that with an input image size of FHD (full high definition), processing A will be adopted as image processing.

There were cases within a closed conventional business system of a specific industry, where it was not necessary to give an instruction for this type of specification with implicit understanding. However, in the future, in the world of the IoT various images will be flying around, constituting training data, and constituting inference model input, and under these types of conditions, situations where manufacturers who have absolutely nothing to do with that field create and provide inference models occur frequently, which means that it is possible to reduce problems an inference model user experiences by displaying a specification list in accordance with strict regulations, as shown in FIG. 21. For example, in cases such as where an inference model is replaced in order to improve detection precision of a specified physical object at the cost of sacrificing detection precision of another specified physical object, or cases such as rewriting a customized inference model, by confirming settings and performing corrections in a list, it is possible to prevent problems such as being significantly changed from before customization.

Also, some of these types of specification can be used for not only at the time of creating an inference model, but also for designation, such as what type of inference is desired at the time of inference. An image that has this type of specification as metadata can be said to be an image that is intended to improve inference model creation, or improve an inference model that already exists. However, whether to adopt as training data of the inference model is not necessarily limiting, and determination is performed using various restrictions and workmanship at the time of learning. Although this image is an image that can be a candidate for training data and test data, it is not known for which it will be used as a candidate. Also, in a case where an image having some of the specification information can already be used in an inference model, it is possible to make that image an image that is suitable for inference by using inference input.

Also, the number of input image systems item is for designating that input images are switched between two systems, and as a result of this designation the inference engine 104 is capable of input of images from the imaging section 103 and images from other image generating sections.

Also, with this embodiment an auxiliary information item is set. The auxiliary information item is for designating what outputs from which sensors will be used with multi-model inference etc. as auxiliary information. For example, in a case where face detection is performed, detection precision is improved with sensor information of an illuminated environment as auxiliary information, while in the case of being vehicle mounted frames that are used are changed in accordance with speed, and so there is a need to enter speed information, and cooperation with a sensor for inputting speed information becomes important.

The date of delivery item is for designating date of delivery of inference model information. The training data and object item is for designating a delivery folder for training data and a detection object (file), and with the example in FIG. 21 folder X, detection object Y are shown. The other data item is for designating use of data other than images in a case where input is images. For example, when detecting buildings in an image, the other data item is for making it possible to use inclination angle of an image as other data, etc. The test sample item is for designating sample data for inference model test, and in the example of FIG. 21 it is understood that sample data is not provided. The operation conditions and restrictions item is for designating conditions for operating inference and for designating restrictions, and in a case where subject brightness of an image is below a predetermined value at the time of image acquisition, for example, it is possible to designate that inference will not be executed, etc.

The supplementary information item is for designating supplemental information, and it is possible to designate display of frames in image portions that have been detected, and designate display of text. Also, the history information item is for designating history of a previous inference model, using version information, for example.

With this embodiment, an item priority item, is set. The item priority item is for designating which specification items should be prioritized, among the specification setting items, when generating an inference model, and with the example of FIG. 21 it is indicated that priority is set for the order “1, 2, 4, 3, 5, 6”, specifically, the order detection object item, hardware information item, correct solution rate and reliability item, response time item, input image size and other item, and number of input image systems.

Needs required for each inference model are different, and may be speed priority and precision priority. If this type of requirement is not correctly conveyed, then even if the user has gone to the trouble of creating an inference model it may be an inference model that cannot be used. If creation of an inference model is performed again, more time and effort is taken up with the learning, and there will also be disadvantages for the person making the request and for the person who receives the request. What factors have priority is therefore made explicit in the setting specification list.

FIG. 22 is a flowchart for describing operation of the learning request section 200. The control section 201 of the learning request section 200 determines whether or not to perform setting of requirement specification of an inference model that is set in the inference engine 104, in step S201 of FIG. 22. In a case where setting of requirement specification is not performed, the control section 201 determines in step S203 whether or not creation of a training data folder has been designated, and if creation of the training data folder has been designated the training data folder is created in step S205. That is, the control section 201 performs collection of images that constitute training data for inference for cat detection, and annotation attachment. The training data that has been collected is stored in the physical object type A image group 202a of the image classification and storage section 202, as reference training data 202b. Test data 202c is also stored in the physical object type A image group 202a.

In a case where setting of a requirement specification is performed, the control section 201 transitions from step S201 to step S207, and performs setting of specification items shown in FIG. 21, using the specification setting section 204. The specification setting section 204 automatically generates some of the specification items, and other items are created based on input operations by the user. The control section 201 determines whether or not input of all specification items has been completed in step S209, and if not complete, processing returns to step S201, while if the setting is complete specification information from specification items that have been set, and training data, are transmitted to the learning section 300 and learning is requested.

In this way, by requesting learning by putting results that have been listed as shown in FIG. 21 into one package, inference model acquisition becomes possible that requires little time and effort to request again. Since learning of an inference model takes time, if learning is performed again etc. a situation will arise where it is not possible to use a desired inference model for some days, causing inconvenience.

As has been described above, with the first and second embodiments, and modified examples of those embodiments, of the present invention, a specification setting section (specification setting section 204 in FIG. 1A, specification setting section 101ba in FIG. 1B, file creation section 101ab and image file with metadata for annotation in FIG. 12) is provided, and metadata is attached to image data. As a result, it is possible to easily create an inference model in accordance with the user's intention. It is also possible to easily attach metadata to image data that was been acquired when the user took pictures.

Also, with the embodiments and modified examples of the present invention, it is possible to provide an image file generating device that generates an image file constituting training data candidates in shooting conditions, and by associating metadata for designating whether purpose of an inference model learned using training data is inference for detecting a physical object within an image, or inference for predicting change in images that are continuous over time, with those images, it becomes possible to apply image learning over a wide range of use. It should be noted that a processor having a metadata generating section that generates metadata may be integral with the imaging section, but with many of the units shown here imaging and image file creation are performed in separate units.

The metadata generating section determines metadata based on information corresponding to times before and after images have been acquired, and so storage and analysis is preferably performed for images before and after image acquisition. A device for such a purpose may be a separate unit that is connected to a network. For example, a server may have a processor that is dedicated to determining (1) if there is an image for inference for detecting a physical object within an image and (2) whether there is an image for inference for predicting change in images that are continuous in time, and a function of metadata attachment, as in this application, may be performed in cooperation with a unit that has a storage section in which continuous images are stored.

Also, besides a metadata attachment server, there may also be a server that provides training data. This server is provided with a processor that has a reception circuit, that receives image data and metadata relating to image data, a collecting section, and a provision section, with the collecting section determining whether purpose information, that has been designated by the metadata of the images, is (1) inference for detecting a physical object within an image or (2) inference for predicting change in images that are continuous in time, and classifying and collecting image data in accordance with results of that determination. Also, the provision section provides image data that has been collected by the collecting section as a training data group.

It should be noted that for the first and second embodiments of the present invention description has been given for a system that comprises a combination of a camera 100, learning request section 200 and learning section 300. However, the present invention is not limited to this combination and the camera 100 may also have the functions of the learning request section 200, and the learning request section 200 may have the functions of the learning section 300. Also, the training data for relearning and the test data may also be data that has been independently generated by the learning request section 200, without regard to training data for relearning and test data from the camera 100.

Also, with the first and second embodiments of the present invention, learning in the learning device has been performing of deep learning, but this is not limiting, and may also be learning that uses artificial intelligence, such as machine learning. Also, in recent years, it has become common to use artificial intelligence, such as being able to determine various evaluation criteria in one go, and it goes without saying that there may be improvements such as unifying each branch etc. of the flowcharts shown in this specification, and this is within the scope of the present invention.

Also, with the first and second embodiments of the present invention, within the learning section 300, the population creation section 302, reference training data storage section 303, input output modeling section 304, communication section A305a, and communication section B305b etc. have been constructed separately to the control section 301. Also, within the learning request section 200 the image classification and storage section 202, communication section B203, specification setting section 204, inference engine 205 etc. have been constructed separately to the control section 201. Further, within the camera 100 the operation section 102, imaging section 103, inference engine 104, storage section 105, and display section 106 have been form separately from the control section 101. However, these configurations are not limiting, and some or all of the sections may be configured as software, and executed by CPUs within the control sections 101, 201 and 301.

Also, sections within the control section 101 may also be provided using hardware circuits outside the control section. Also, the use of the CPU is not limiting, and as long as there is an element that can perform the functions as a controller, processing for each of the above describe sections may also be performed by one or more processors constructed as hardware. For example, each section may be configured as a processor that is constructed as respective electronic circuits, and may be respective circuit sections of a processor that has been constructed using integrated circuits, such as an FPGA (Field Programmable Gate Array). Also, a processor that is made up of one or more CPUs may be configured so as to execute the functions of respective sections, by reading out and executing computer programs that have been stored in a storage medium. It is also possible for each of the above described sections to have a hardware structure such as gate circuits that have been generated based on a programming language that is described using Verilog, and also to use a hardware structure that utilizes software such as a DSP (digital signal processor). Suitable combinations of these approaches may also be used.

Also, with the one embodiment of the present invention, a camera 100 has been described using a digital camera, but as a camera it is also possible to use a digital single lens reflex camera or a compact digital camera, or a camera for movie use such as a video camera, and further to have a camera that is incorporated into a mobile phone, a smartphone a portable information terminal, personal computer (PC), tablet type computer, game console etc., a camera for medical use, or a camera for a scientific instrument such as a microscope, a camera for mounting on a vehicle, a surveillance camera etc. As a camera for medical use, it is possible to apply the present invention to cases where, for example, images that have been taken are used as training data for creating an inference model for diagnosis and therapeutic use.

Also, in recent years, it has become common to use artificial intelligence, such as being able to determine various evaluation criteria in one go, and it goes without saying that there may be improvements such as unifying each branch etc. of the flowcharts shown in this specification, and this is within the scope of the present invention. Regarding this type of control, as long as it is possible for the user to input whether or not something is good or bad, it is possible to customize the embodiments shown in this application in a way that is suitable to the user by learning the user's preferences. Since a user will not necessarily have an abundance of content constituting training data that is suitable for learning, there will be more cases where inference model creation is requested using content the user has themselves, in addition to content that has been saved by a third party. Even under such circumstances, according to each of the embodiments of the present invention it becomes possible to perform ordering etc. without anxiety. In recent years samples of movies etc. have been circulated widely on the Internet, and as a result there are many users who want to use these samples. Since audio information is also contained in a movie, in this specification sections that have been described using “images” may also be images having audio, and may be inference models for audio.

In this way, if it is possible to promptly determine, in a scene for acquiring information (images and audio, and others), whether inference results of an inference model are good or bad, and what the limits are, it becomes possible to provide a unit that can satisfy inference results that are desired by users the more that it is used. With these types of scheme, it is possible to provide technology and services that can acquire inference models that are more suitable to actual scenes and exceed design levels. A predictive guide has an advantage that it is possible to reduce the user's valuable waiting time. Using a predictive guide, it is possible for the user to be mentally prepared.

Also, besides various machine learning for images and audio, in consideration of confidentiality, portrait rights and copyright considered by this application, maintaining of security, including risks such as data scarcity and falsification, and protection of individual information, and protection of knowhow, it becomes possible to request relearning or tuning without data to hand being disclosed. Even if the user is not an individual, request conditions have a similar inclination in companies also. Also, at the side receiving a request also, there is a tendency for a user to be reluctant to use images, audio, and other data that have a problem of individual information or confidentiality. Accordingly, for data other than those that are at hand also, in order to easily obtain a specific inference model from specific conditions that the user has assumed, there is a need for a system that is capable of simple customization and tuning. In a case of performing annotation for other than images, in the case of voice, for example, it is possible to also utilize this application if it is intended to improve recognition rate of a specified voice at the time of speech recognition.

Also, in this application it has been described that specification of an inference model from a user focused on relearning is acquired as metadata of an image file, from the viewpoint of conditions in which it is difficult for the user to gather large amounts of training data. However, the present invention is not limited to relearning, and it is also possible to apply the technology shown in this application to a case of requesting learning with an image file from a user, for example, as actual training data (first training data). This type of situation may arise for heavy users.

Also, in the above described embodiments, information for annotation is associated with an image file in a metadata format of the image file. However, this method is not limiting and other associating methods may also be used. For example, there is also a method of solving system problems such that an image file is transmitted, and information associated with a file name is transmitted together.

Also, among the technology that has been described in this specification, with respect to control that has been described mainly using flowcharts, there are many instances where setting is possible using programs, and such programs may be held in a storage medium or storage section. The manner of storing the programs in the storage medium or storage section may be to store at the time of manufacture, or by using a distributed storage medium, or they be downloaded via the Internet.

Also, with the one embodiment of the present invention, operation of this embodiment was described using flowcharts, but procedures and order may be changed, some steps may be omitted, steps may be added, and further the specific processing content within each step may be altered. It is also possible to suitably combine structural elements from different embodiments.

Also, regarding the operation flow in the patent claims, the specification and the drawings, for the sake of convenience description has been given using words representing sequence, such as “first” and “next”, but at places where it is not particularly described, this does not mean that implementation must be in this order.

As understood by those having ordinary skill in the art, as used in this application, ‘section,’ ‘unit,’ ‘component,’ ‘element,’ ‘module,’ ‘device,’ ‘member,’ ‘mechanism,’ ‘apparatus,’ ‘machine,’ or ‘system’ may be implemented as circuitry, such as integrated circuits, application specific circuits (“ASICs”), field programmable logic arrays (“FPLAs”), etc., and/or software implemented on a processor, such as a microprocessor.

The present invention is not limited to these embodiments, and structural elements may be modified in actual implementation within the scope of the gist of the embodiments. It is also possible form various inventions by suitably combining the plurality structural elements disclosed in the above described embodiments. For example, it is possible to omit some of the structural elements shown in the embodiments. It is also possible to suitably combine structural elements from different embodiments.

What is claimed is:

1. An image file generating device that generates image files constituting training data candidates, comprising:
a processor having a metadata generating section for generating metadata for designating
(1) if inference is for detecting a physical object within an image, and
(2) if inference is for predicting change in images that are continuous in time series, wherein
the metadata generating section generates the metadata based on information corresponding to time before and after the images have been acquired.

2. The image file generating device of claim 1, wherein:
as information corresponding to time before and after images have been acquired, the metadata generating section, in a case where there are images that have been selected by the user, generates metadata for prediction inference for predicting change in images that are continuous in time, with time of that acquisition as the information, or, if there is acquisition of specified sensor information, generates metadata with acquisition time of the sensor information as the information.

3. The image file generating device of claim 1, wherein:
the metadata generating section generates metadata for inference in order to detect a physical object within the image, in accordance with whether it was possible to detect part of an image corresponding to a specific physical object, within images that have been acquired at times before and after images have been acquired, as information corresponding to times before and after images have been acquired.

4. The image file generating device of claim 2, wherein:
the metadata generating section generates metadata with retroactive times as annotation information, in the event that specified purpose information is for prediction inference.

5. The image file generating device of claim 1, wherein:
the metadata generating section determines predicted value in the above described prediction purpose, by external sensor synchronized determination that automatically determines specified conditions and/or release determination using a manual operation to confirm and perform a user's live view display.

6. The image file generating device of claim 1, further comprising:
memory that stores the sensor synchronized determination and/or the release determination, as the information corresponding to time before and after acquisition.

7. The image file generating device of claim 1, wherein:
the metadata generating section makes information as to whether information was selected subjectively or selected objectively, into metadata as information corresponding to time before and after acquisition.

8. The image file generating device of claim 1, wherein:
in a case where it has been determined that inference is for detecting a physical object within an image, the metadata generating section generates information for image quality of a physical image to be determined by an inference model that is created, or for images in which physical object changes in association with an act.

9. The image file generating device of claim 1, wherein:
further, the metadata generating section generates information as to whether the image data will be made training data for externally requested learning, or made hidden reference data, as metadata.

10. The image file generating device of claim 1, further comprising:
an inference engine that detects specific sections of an image by inference, using an inference model, wherein,
the metadata generating section creates the metadata in a case where inference results using the inference engine have failed.

11. An image file generating method for generating image files having training data candidates, comprising:
inputting purpose information that has been designated; and
generating metadata for designating that purpose of an inference model that will be created is for prediction, wherein
regarding the generation of the metadata, at the time of creating an inference model in which images associated with image data are made training data candidates, when the purpose information that has been designated is for prediction, metadata is generated with retroactive time as annotation information.

12. The image file generating method of claim 11, wherein:
further, in the metadata generation, predicted value in the above described prediction purpose is determined by external sensor synchronized determination that automatically determines specified conditions and/or release determination using a manual operation to confirm and perform a user's live view display.

13. The image file generating method of claim 11, wherein:
the sensor synchronized determination and/or release determination are stored in memory.

14. The image file generating method of claim 11, wherein:
in the generating of the metadata, further, information as to whether determination of the predicted value is subjective or objective is made into metadata, with sensor synchronization being made objective, and release being made subjective.

15. The image file generating method of claim 11, wherein:
in the metadata generation, metadata is generated with images that are not for prediction as candidates for detection usage for detecting a physical object contained in an image.

16. The image file generating method of claim 11, wherein:
in the generation of metadata, information as to whether what is being determined by an inference model to be further created is for quality of that image itself, or images that change in association with an event, is generated.

17. A server that provides training data, comprising:
a reception circuit that receives image data and metadata relating to the image data, and
a processor having a collecting section and a provision section, wherein
the collecting section determines whether purpose information that has been designated by the metadata is (1) inference for detecting a physical object within an image, or is (2) inference for predicting change of images that are continuous in time series, and gathers image data by classifying in accordance with the result of determination, and
the provision section provides image data that has been collected by the collecting section as a training data group.

18. The server of claim 17, wherein:
if the purpose information that has been designated is for prediction, the metadata is generated with retroactive times as annotation information.
